(19) United States
(12) Patent Application Publication
(10) Pub. No.: US 2025/0307801 A1
(43) Pub. Date: Oct. 2, 2025

(54) INFORMATION PROCESSING SYSTEM AND INFORMATION PROCESSING METHOD

(71) Applicant: Hitachi, Ltd., Tokyo (JP)

(72) Inventors: Satoshi ITO, Tokyo (JP); Takayuki NAGAI, Tokyo (JP); Yusuke ARAI, Tokyo (JP)

(21) Appl. No.: 18/887,294

(22) Filed: Sep. 17, 2024

(30) Foreign Application Priority Data
Mar. 26, 2024 (JP) 2024-049702

(51) Int. Cl. G06Q 20/36

(52) U.S. Cl. CPC G06Q 20/3674

(57) ABSTRACT

In an information processing system that provides a function for issuing or verifying a verifiable credential and a verifiable presentation, which is implemented between a plurality of organizations by a self-sovereign identity (SSI) technology, a creation request of extraction information specifying storage or non-storage, for information in the verifiable credential, in a blockchain (BC) of a distributed ledger system is received from a node, an approval or non-approval of information specifying storage or non-storage in creation request information generated based on the creation request is determined by consensus formation in the distributed ledger system, and the extraction information is created based on the creation request information when consensus is reached. BC storage information to be stored in a distributed ledger is created based on a schema or a credential definition and the extraction information.

### CROSS-REFERENCE TO RELATED APPLICATION

The present application claims priority pursuant to 35 U.S.C. § 119 to Japanese Patent Application No. 2024-049702 filed on Mar. 26, 2024, the entire disclosure of which is hereby incorporated herein by reference.

### BACKGROUND OF THE INVENTION

### 1. Field of the Invention

The present invention relates to an information processing system and an information processing method.

### 2. Description of Related Art

In recent years, a technology has emerged that allows transactions, which are previously conducted through centralized institutions such as financial institutions and governments, to be recorded in a distributed ledger (Blockchain, hereinafter referred to as a “BC”) managed by a Peer-to-Peer (P2P) network system (hereinafter referred to as a “distributed ledger system”) implemented using information processing apparatuses of individual users and thus be conducted directly between users without the need for centralized institutions and the like (hereinafter referred to as a “distributed ledger technology”), which is being increasingly applied across various fields.

With regard to the distributed ledger technology, for example, NPL 1 discloses that a BC is used in an automobile supply chain for handling parts recalls, tracing parts, collecting greenhouse gas emissions, and reducing counterfeit parts.

As in NPL 1, when information on a customer who owns a vehicle is stored in the BC, all organizations participating in the distributed ledger system can access the customer information, and a risk of personal information leakage increases. Therefore, in recent years, a “self-sovereign identity technology” (SSI technology) has attracted attention.

With regard to the SSI technology, for example, NPL 2 discloses a technology for verifying a credential issued by a third party using a verifiable credential (VC) or a verifiable presentation (VP) presented to a verifier (Verifier).

NPL 3 discloses a method of management using the SSI technology from manufacturing to disposal of an automobile battery.

### CITATION LIST

### Non Patent Literature

NPL 1: “Supply Chain Use Cases & Business Requirements”, [online], [retrieved Mar. 7, 2024], Internet dlt.mobi/wp-content/uploads/2023/07/MOBI-SC0001UC2021-Version-1.1.pdf
NPL 2: “Verifiable Credentials Data Model v2.0”, [online], [retrieved Mar. 7, 2024], Internet www.w3.org/TR/vc-data-model-2.0/
NPL 3: “Global Battery Passport”, [online], [retrieved Mar. 7, 2024], Internet dlt.mobi/wp-content/uploads/2023/07/MOBI-BP0001TG2023-Version-1.1-1.pdf

### SUMMARY OF THE INVENTION

The technology disclosed in NPL 1 allows all organizations participating in the distributed ledger system to access information stored in the BC, and a risk of information leakage increases. The technology disclosed in NPL 3 enables prevention of leakage of information for managing from manufacturing to disposal of the automobile battery by the SSI technology, but since a history of information exchanged (transacted) when using the SSI technology is not managed on the BC as in NPL 1, traceability of the exchanged information is reduced.

The invention has been made to solve the above problems, and an object thereof is to provide an information processing system and an information processing method that can prevent leakage of information using the SSI technology and ensure traceability of information exchanged when using the SSI technology.

In order to accomplish the above object, an aspect of the invention provides an information processing system including a plurality of nodes that are implemented using an information processing apparatus and are communicably connected to each other, in which at least a part of the plurality of nodes constitute a distributed ledger system that provides a distributed ledger, the distributed ledger system enables execution of a smart contract according to a transaction sent from the plurality of nodes, at least a part of the plurality of nodes provides a function for issuing or verifying a verifiable credential and a verifiable presentation, the function being implemented among a plurality of organizations by a self-sovereign identity (SSI) technology, the information processing system manages, as the smart contract, a program that implements a creation request information generation function of receiving, from the nodes, a creation request for extraction information that is information specifying, for information in the verifiable credential, storage or non-storage in the distributed ledger of the distributed ledger system, and generating creation request information that is information based on the received creation request, an approval or non-approval function of determining, by consensus formation among the nodes constituting the distributed ledger system, an approval or non-approval of the information specifying the storage or non-storage in the creation request information, and an extraction information creation function of creating, when consensus is reached by the consensus formation, the extraction information based on the creation request information, creates the extraction information by activating the creation request information generation function, the approval or non-approval function, and the extraction information creation function, extracts information from the verifiable credential or the verifiable presentation based on a schema or a credential definition managed in the SSI technology and the extraction information, and creates BC storage information that is information to be stored in the distributed ledger based on the extracted information.

In addition, other problems disclosed by the present application and methods for solving the problems will be made clear by the section of the embodiments for carrying out the invention and the drawings.

According to the invention, it is possible to prevent leakage of information using the SSI technology and ensure traceability of information exchanged when using the SSI technology.

### BRIEF DESCRIPTION OF THE DRAWINGS

FIG. 1A shows a flow when extraction information is created based on a verifiable credential (VC).

FIG. 1B shows a flow of creation of BC storage information in a first embodiment.

FIG. 2 shows a schematic configuration of a distributed ledger system.

FIG. 3 shows a flow from issuance of a verifiable credential (VC) to verification of a verifiable presentation (VP).

FIG. 4 shows main functions of an SSI application.

FIG. 5A shows an example of a data structure of a block of a BC.

FIG. 5B shows a data structure of a block following the block in FIG. 5A.

FIG. 5C shows a data structure of a block following the block in FIG. 5B.

FIG. 5D shows a data structure of a block following the block in FIG. 5C.

FIG. 6 shows an example of state information.

FIG. 7 shows an example of consortium information.

FIG. 8 shows an extraction information management SC.

FIG. 9 shows an example of creation request information.

FIG. 10 shows an example of extraction information.

FIG. 11 is a flowchart showing SC deployment and execution processing.

FIG. 12 is a flowchart showing creation request information generation processing.

FIG. 13 is a flowchart showing approval or non-approval processing.

FIG. 14 is a flowchart showing extraction information creation processing.

FIG. 15 is a flowchart showing processing of creating BC storage information.

FIG. 16 shows an example of a creation request execution screen.

FIG. 17 shows an example of an approval or non-approval setting screen.

FIG. 18 shows an example of a BC storage information creation screen.

FIG. 19 shows an example of group information.

FIG. 20 shows a flow of creation of BC storage information in a second embodiment.

FIG. 21 is a flowchart showing BC storage information creation processing.

FIG. 22 is a flowchart showing unique ID assignment processing.

FIG. 23 shows an example of an information processing apparatus used to implement a distributed ledger system.

### DESCRIPTION OF EMBODIMENTS

Hereinafter, embodiments of the invention will be described with reference to the drawings. The following embodiments are merely examples for describing the invention, and are omitted and simplified as appropriate for clarity of the description. The invention can be implemented in various other forms. Unless otherwise specified, each component may be single or plural.

Hereinafter, examples of various types of information may be described using expressions such as “information” and “data”, and the various types of information may also be expressed using data structures other than these (“table”, “chart”, and the like).

In the following description, when identification information is described, expressions such as “identifier”, “ID”, and “identification information” may be used, and these expressions can be replaced with one another.

In the following description, a letter “S” before a reference sign means a processing step.

In the following description, a function implemented by “application software” is referred to as an “application”.

Hereinafter, a technology for enabling a direct transaction between users using a blockchain (distributed ledger) (hereinafter, also referred to as a “BC”) in a distributed ledger technology is referred to as a “distributed ledger technology”.

A peer-to-peer (P2P) communication network serving as a basis for using the distributed ledger technology is hereinafter referred to as a “distributed ledger network” or a “consortium”. The distributed ledger network is implemented using a plurality of information processing apparatuses (hereinafter, referred to as “distributed ledger nodes”) that perform bidirectional communication with each other through the communication network. An organization such as a company or a government agency that participates in (uses) the distributed ledger network is referred to as a “participating organization”. Hereinafter, an information processing system implemented using the distributed ledger network is referred to as a “distributed ledger system 1”.

A smart contract executable in the distributed ledger system 1 is also referred to as “SC” hereinafter. A transaction issued to the smart contract is also referred to as a “TX”. An entity of the smart contract is a program deployed to the distributed ledger system 1. An executing entity of the smart contract is the distributed ledger node constituting the distributed ledger system 1.

The distributed ledger system 1 includes a client node 4 that is an information processing apparatus operated in each organization, and a distributed ledger node 3 that is an information processing apparatus provided to the distributed ledger network by each organization. These nodes are connected to each other in a state in which bidirectional communication is available.

In the following description, it is assumed that the participating organization or a member of the participating organization is identified by a combination of a secret key and a verifiable credential (hereinafter also referred to as an “identity”) of a public key encryption method.

### SSI Technology

A self-sovereign identity (SSI) technology refers to a technology that can selectively disclose one's own information to a third party using a verifiable credential (VC). For example, when checking an age at a restaurant, a customer is required to present a license or a health insurance card. At this time, although the only content to be verified by the restaurant is whether the age of the customer reaches a legal drinking age, the customer still needs to present information other than the age, such as a name or an address, to the restaurant. In such a case, by using the SSI technology, it is possible to present only a part of information in the VC, instead of presenting all information in the VC to a verifier (Verifier) of the VC. Further, by using a zero-knowledge proof technology, the Verifier can perform verification without disclosing information in the VC.

In order to issue a VC by the SSI technology, it is necessary to store a schema and a credential definition in a data registry that can be verified (hereinafter, also referred to as a “verifiable data registry” (VDR)). The schema is information indicating what information is contained in the VC. For example, in a case where the VC is a school graduation certificate, the schema describes information indicating that the VC includes a name, a school name, a department name, and a graduation date. The credential definition includes a decentralized identifier (DID) (also referred to as a “decentralized ID”) that is an identifier of a credential issuing organization (Issuer) and public key information.

The Issuer issues a VC that can be verified by a credential holder (Holder) using a secret key corresponding to a public key in the credential definition stored in the VDR. The Holder verifies the VC using the schema and the credential definition stored in the VDR.

The Holder creates, from the VC, a verifiable presentation (hereinafter, referred to as a “VP”) to be presented to the Verifier. By using the presented VP and the schema and the credential definition stored in a distributed ledger, the Verifier verifies information in the VP. The VP is signed using the secret key of the Issuer when the VC is issued. Therefore, the Verifier can verify the VP using the public key of the Issuer.

### First Embodiment

In the present embodiment, the distributed ledger system 1 will be described in which a mechanism is provided to store information handled when the SSI technology is used in a BC and thus reduce a decrease in traceability caused by using the SSI technology.

In the present embodiment, information stored in the BC (hereinafter referred to as “BC storage information”) is information extracted from a verifiable credential (VC), and is information handled when issuing or verifying the VC or a verifiable presentation (VP) in the SSI technology.

In the distributed ledger system 1, when a credential issuing organization (Issuer) issues a VC based on a schema managed by the SSI technology, the BC storage information is created based on information specifying information to be extracted from the VC (hereinafter, referred to as “extraction information”).

The distributed ledger system 1 creates the extraction information with consensus from participating organizations. When the extraction information is created, a participating organization such as the Issuer presents a creation request of the extraction information including a content specifying information to be stored in the BC and information not to be stored in the BC to another participating organization via the distributed ledger system 1. The other participating organization determines whether to approve a content of the presented creation request or not (hereinafter, referred to as an “approval or non-approval”), and notifies the distributed ledger system 1 of a determined result. The distributed ledger system 1 creates the extraction information, for example, when the number of participating organizations that approve the creation request exceeds a predetermined number or ratio.

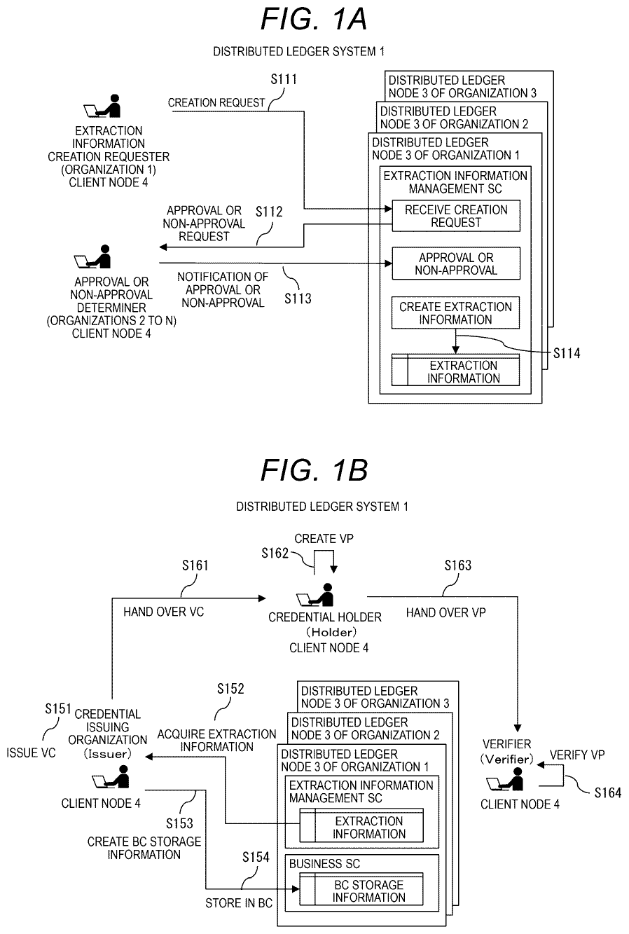

FIG. 1A shows a flow when the extraction information is created based on the VC. In the following description, an “extraction information management SC” refers to a smart contract that executes processing related to the creation of the extraction information.

In the present embodiment, it is assumed that there is at least one distributed ledger node 3 and at least one client node 4 in each participating organization (a credential issuing organization (Issuer), a credential holder (Holder), a verifier (Verifier), or the like). However, the configuration of the distributed ledger system 1 may be another configuration as long as decentralization can be ensured (a single point of trust is avoided). For example, regarding the client node 4, a smart contract can be shared by a plurality of users by switching authentication information attached to a transaction for each user. A participating organization that does not approve a transaction may not necessarily own the distributed ledger node 3.

As shown in the FIG. 1A, first, an entity that requests creation of extraction information in an “organization 1” that is a participating organization (hereinafter, referred to as a “requesting organization”) creates a creation request and performs notification to the distributed ledger node 3 of the “organization 1” (S111).

When the creation request is notified of, the distributed ledger node 3 of the “organization 1” requests distributed ledger nodes 3 of other participating organizations, that is, an “organization 2” to an “organization N”, to determine an approval or non-approval for the creation request (S112).

Each of the distributed ledger nodes 3 of the other participating organizations that receive the request transmits a result of the approval or non-approval to the distributed ledger node 3 of the “organization 1” (S113).

Subsequently, the distributed ledger system 1 comprehensively determines a result of the approval or non-approval of each participating organization, and creates the extraction information based on the creation request (S114).

FIG. 1B shows an overview of a flow from when the Issuer issues the VC based on the extraction information created in FIG. 1A to when the BC storage information is created from the VC and stored in the BC, and a flow from when the Holder issues the VP based on the VC and hands the VP over to the Verifier to when the Verifier verifies the VP. In the following description, it is assumed that the extraction information corresponding to the schema related to the VC is stored in advance in the distributed ledger system.

First, the Issuer operates the client node 4 to issue the VC (S151).

Subsequently, the Issuer operates the client node 4 to acquire the extraction information corresponding to the schema related to the issued VC (S152).

Subsequently, the Issuer operates the client node 4 to create the BC storage information based on the acquired extraction information and the VC (S153), and stores the created BC storage information in the BC (S154).

Subsequently, the flow from when the Holder issues the VP based on the VC and hands the VP over to the Verifier to when the Verifier verifies the VP will be described.

First, the Issuer operates the client node 4 to hand the VC created in S151 over to the Holder (S161).

The Holder operates the client node 4 to create the VP based on the received VC (S162), and hands the created VP over to the Verifier (S163).

The Verifier operates the client node 4 to verify that the received VP is a credential correctly issued by the Issuer (S164).

### Distributed Ledger System

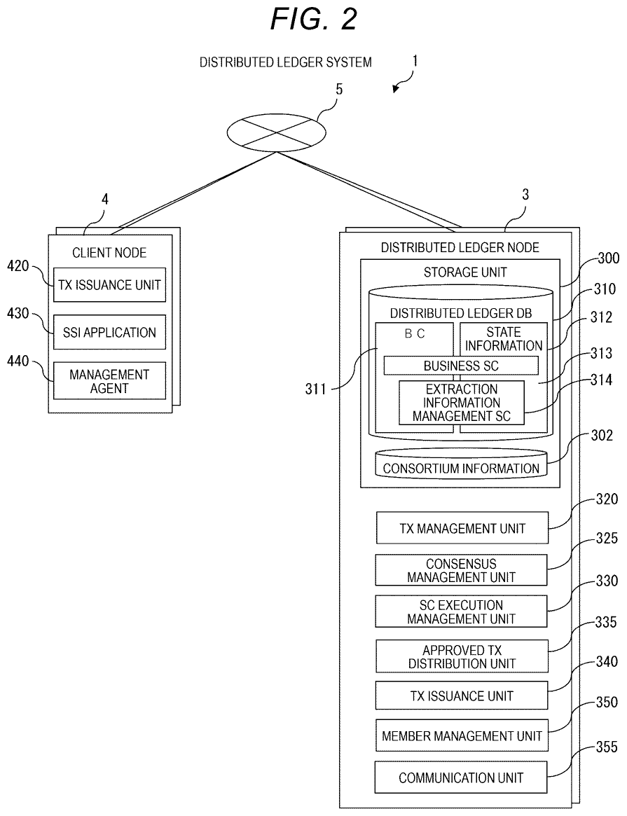

FIG. 2 shows a schematic configuration of the distributed ledger system 1. As shown in the FIG. 2, the distributed ledger system 1 includes one or more distributed ledger nodes 3 and one or more client nodes 4.

Each of the distributed ledger node 3 and the client node 4 is implemented using an information processing apparatus (computer). The distributed ledger node 3 and the client node 4 are connected to each other via a communication network 5 in a state in which bidirectional communication is available. The communication network 5 is a wireless or wired communication infrastructure implemented using a physical communication line, and is, for example, the Internet, a local area network (LAN), a wide area network (WAN), various public communication networks, or a dedicated line.

As shown in the FIG. 2, the distributed ledger node 3 has functions of a storage unit 300, a transaction management unit (hereinafter, referred to as a “TX management unit 320”), a consensus management unit 325, a smart contract execution management unit (hereinafter, referred to as an “SC execution management unit 330”), an approved TX distribution unit 335, a transaction issuance unit (hereinafter, referred to as a “TX issuance unit 340”), a member management unit 350, and a communication unit 355.

The distributed ledger node 3 receives a transaction by the TX management unit 320, and executes, by the consensus management unit 325, consensus formation with another distributed ledger node 3 to determine whether the transaction is to be accepted. When consensus is reached, the distributed ledger node 3 deploys and executes a smart contract via the SC execution management unit 330, and stores a transaction history and an execution result in a distributed ledger DB 310.

It is not always necessary for all the distributed ledger nodes 3 to execute the consensus formation and the smart contract, the consensus formation and the smart contract may be executed among a part of the distributed ledger nodes 3, and a result thereof may be distributed to other distributed ledger nodes 3. An agreement in this case depends on a consensus formation algorithm.

Among the above functions, the storage unit 300 manages (stores, records, and retains) the distributed ledger DB 310 and consortium information 302.

The distributed ledger DB 310 includes a BC (hereinafter, referred to as a “BC 311”), state information 312, a business SC 313 that is a smart contract for implementing processing related to an organization business, and an extraction information management SC 314.

The BC 311 manages the transaction history (reception history and execution history).

In the state information 312, information based on the transaction history and information necessary for execution of the smart contract (hereinafter referred to as “state information”) are managed. The state information 312 is managed in, for example, a table in a data base managed by a data base management system (DBMS) such as the BC 311 or NOSQL. The state information 312 includes, for example, information based on an execution result of the transaction managed in a key-value format.

The consortium information 302 includes information on participating organizations, and information such as various consensus conditions determined among the participating organizations. The consortium information 302 is shared among the distributed ledger nodes 3 of each organization. The consortium information 302 includes various types of information on a consortium such as the information on the participating organizations, a consensus condition for accepting the transaction related to execution of the smart contract (hereinafter, referred to as an “SC consensus condition”), and a consensus condition for accepting a transaction for changing distributed ledger network setting. The SC consensus condition is recorded in the distributed ledger DB 310.

The TX management unit 320 receives the transaction sent from another information processing apparatus such as the client node 4. The TX management unit 320 also executes processing related to acquisition of the transaction history (reception history and execution history) and the execution result, presentation of the execution result of the transaction (presentation via a user interface, or the like), addition of a signature to the transaction, and the like. Upon receiving the transaction, the TX management unit 320 cooperates with the member management unit 350 and executes processing related to authentication and signature of an issuer (the client node 4, a member, or the like) of the transaction. In the present embodiment, an authority of the issuer of the transaction can be determined based on information described in a credential.

The consensus management unit 325 executes processing related to consensus formation with another distributed ledger node 3 to determine whether the transaction received from the client node 4 or the distributed ledger node 3 is to be accepted. When consensus is reached, the consensus management unit 325 cooperates with the SC execution management unit 330 to deploy the smart contract, execute the deployed smart contract, and record the transaction history and the transaction execution result in the distributed ledger DB 310.

When the consensus with the other distributed ledger node 3 is reached, the SC execution management unit 330 executes processing related to smart contract deployment and execution of the deployed smart contract. It is not necessary for all the distributed ledger nodes 3 constituting the distributed ledger network to always execute the consensus formation and the smart contract, the consensus formation and the smart contract may be executed among a part of the distributed ledger nodes 3, and a result thereof may be distributed to the other distributed ledger nodes 3 via the communication network 5 in cooperation with the approved TX distribution unit 335. An agreement in this case depends on a consensus formation algorithm.

The approved TX distribution unit 335 distributes, via the communication network 5, the result (the transaction history, the execution result, and the like) of the execution of the consensus formation and the smart contract to the distributed ledger nodes 3 that do not participate in the execution of the consensus formation and the smart contract. In a consortium-based distributed ledger system, each organization operates a distributed ledger node. The communication unit 355 performs communication between the distributed ledger nodes 3, such as consensus formation or distribution of approved transactions between nodes.

The TX issuance unit 340 issues the transaction to the distributed ledger node 3.

The member management unit 350 executes, using a credential and a secret key corresponding to the credential, authentication processing of the participating organization or a member of the participating organization. The member management unit 350 performs, for example, authentication of the participating organization or the member belonging to the participating organization using a combination of a secret key and a public key (hereinafter, referred to as a “key pair”), transaction signing, and control of an authority to execute the smart contract.

The communication unit 355 executes processing related to communication with the client node 4 or another distributed ledger node 3 via the communication network 5. For example, the communication unit 355 performs communication related to consensus formation with other distributed ledger nodes 3, and distribution of an approved transaction to other distributed ledger nodes 3.

As shown in the FIG. 2, the client node 4 has functions of a TX issuance unit 420, an SSI application 410, and a management agent 440.

The TX issuance unit 420 issues a transaction to the distributed ledger node 3. A user of a smart contract issues various transactions via the TX issuance unit 420 of the client node 4 and transmits the transactions to the distributed ledger node 3. Information related to an issuer (hereinafter referred to as “issuer information”) is attached to the transactions. In the present embodiment, the above-described identity is used as the issuer information.

The SSI application 410 is used to issue a transaction related to the extraction information management SC 314 and refer to information on a public key or a DID of a schema or a credential issuing organization used in the SSI technology via the TX issuance unit 420. The SSI application 410 executes processing related to issuance and verification of the VC and issuance and verification of the VP.

The management agent 440 executes processing related to smart contract deployment, participating organization addition, and the like for the distributed ledger node 3. The management agent 440 also receives a notification (hereinafter, referred to as an “SC event”) sent from the extraction information management SC 314 of the distributed ledger node 3. When the processing related to the received SC event is completed, the management agent 440 issues a transaction to the extraction information management SC 314 of the distributed ledger node 3 and performs notification of a processing result of the SC event.

### SSI Application

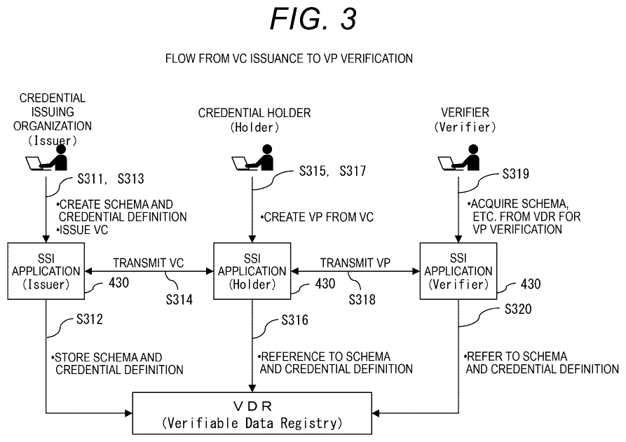

FIG. 3 shows a flow from issuance of a VC to verification of a VP, which is executed using the SSI application 410 of the client node 4.

When issuing the VC, a credential issuing organization (Issuer) creates a schema and a credential definition by the SSI application 410 (S311), and stores the created schema and credential definition in a VDR (S312). Since the credential definition includes public key information, the Issuer creates a key pair in advance using the SSI application 410.

A method for implementing the VDR is not limited, and the VDR may be implemented using, for example, DBMS. In the present embodiment, the VDR is implemented by the distributed ledger DB 310. In the VDR, the schema and the credential definition are described in, for example, a JavaScript Object Notation (JSON) (“Java” and “JavaScript” are both registered trademarks) format.

Subsequently, the Issuer creates, using the secret key created in advance, the VC to be handed over to a credential holder (Holder) (S313). In the present embodiment, the BC storage information is created based on the VC using the SSI application 410 at this timing (a timing when the VC is issued).

Subsequently, the Issuer transmits, using the SSI application 410, the created VC to the Holder (S314).

The Holder acquires, using the SSI application 410, the schema and the credential definition corresponding to the VC received from the Issuer from the VDR, and verifies whether the VC is correct using the acquired schema and credential definition (S315, S316). When the VC is not correct, the Holder requests the Issuer to re-create a credential, for example.

Subsequently, the Holder creates the VP (S317). The VP includes a part or all of information in the VC. The VC and the VP are described in, for example, the Javascript Object Notation (JSON) (“Java” and “JavaScript” are both registered trademarks) format.

Subsequently, the Holder transmits, using the SSI application 410, the created VP to a verifier (Verifier) (S318).

The Verifier acquires, using the SSI application 410, the schema and the credential definition from the VDR, which are used for verifying the VP received from the Holder, and verifies the VP using the acquired information. The verification is executed, for example, by checking presence or absence of tampering and validating authenticity (that the VP is created based on the VC issued by the Issuer) (S319, S320).

According to the above flow, the Verifier can verify information issued by the Holder without querying the Issuer.

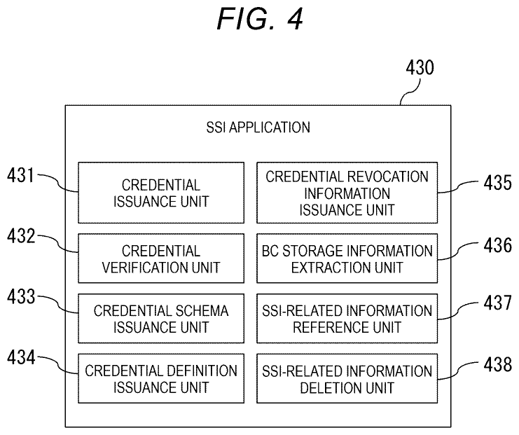

FIG. 4 shows main functions of the SSI application 410. The SSI application 410 provides various functions related to issuance and verification of the VC and the VP. The SSI application 410 executes processing related to viewing information managed in the distributed ledger DB 310 and revocation of the VC.

As shown in the FIG. 4, the SSI application 410 includes functions of a credential issuance unit 431, a credential verification unit 432, a credential schema issuance unit 433, a credential definition issuance unit 434, a credential revocation information issuance unit 435, a BC storage information extraction unit 436, an SSI-related information reference unit 437, and an SSI-related information deletion unit 438.

Among these, the credential issuance unit 431 provides a function related to issuance of the VC and the VP. For example, the Issuer issues the VC using the credential issuance unit 431. The Holder uses the credential issuance unit 431 to extract information to be presented to the Verifier from the VC and create the VP. The VC and the VP include not only information encrypted by the Issuer but also information that is not encrypted.

The credential verification unit 432 executes processing related to verification of the VC and the VP. The credential verification unit 432 cooperates with the SSI-related information reference unit 437 to verify the VC and the VP using information stored in the BC 311.

The credential schema issuance unit 433 creates a schema used when issuing the VC. The credential schema issuance unit 433 stores the created schema in the distributed ledger DB 310.

The credential definition issuance unit 434 creates a credential definition used when creating the VC and stores the created credential definition in the distributed ledger DB 310.

The credential revocation information issuance unit 435 creates information for revoking (disabling verification of) the VC and manages the created information in the distributed ledger DB 310. The credential revocation information issuance unit 435 manages various types of information on the revocation of the VC in the distributed ledger DB 310.

The BC storage information extraction unit 436 extracts, from the VC, information used for creating the BC storage information in cooperation with the SSI-related information reference unit 437 based on the extraction information managed in the distributed ledger DB 310. The BC storage information extraction unit 436 issues a transaction for storing the BC storage information in the BC 311.

The SSI-related information reference unit 437 accesses the distributed ledger DB 310 to acquire (refer to) various types of information managed in the distributed ledger DB 310. For example, the SSI-related information reference unit 437 refers to (acquires) the information stored in the distributed ledger DB 310 when verifying the VC or the VP or when extracting a part of information from the VC or the VP.

The SSI-related information deletion unit 438 deletes the information (including the BC storage information) managed in the distributed ledger DB 310. The SSI-related information deletion unit 438 deletes information stored in the BC 311 in cooperation with the TX issuance unit 420 of the client node 4. When the SSI-related information deletion unit 438 issues, to the distributed ledger system 1, a transaction instructing execution of a smart contract for deleting the information in the BC 311, each distributed ledger node 3 executes the smart contract to delete the information in the BC 311.

### BC (Blockchain)

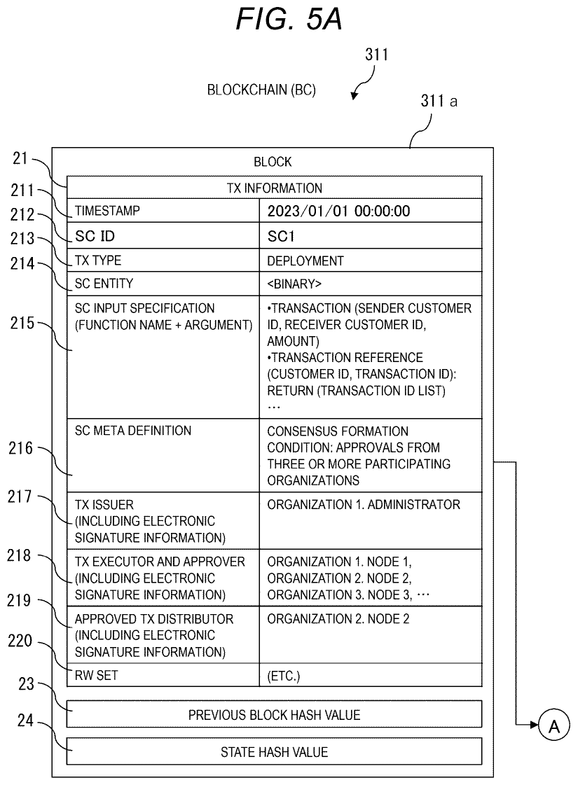

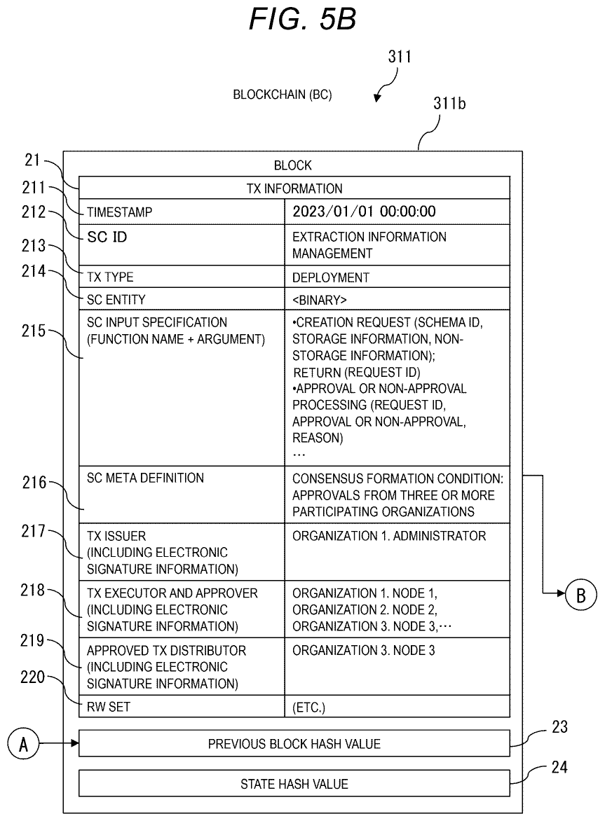

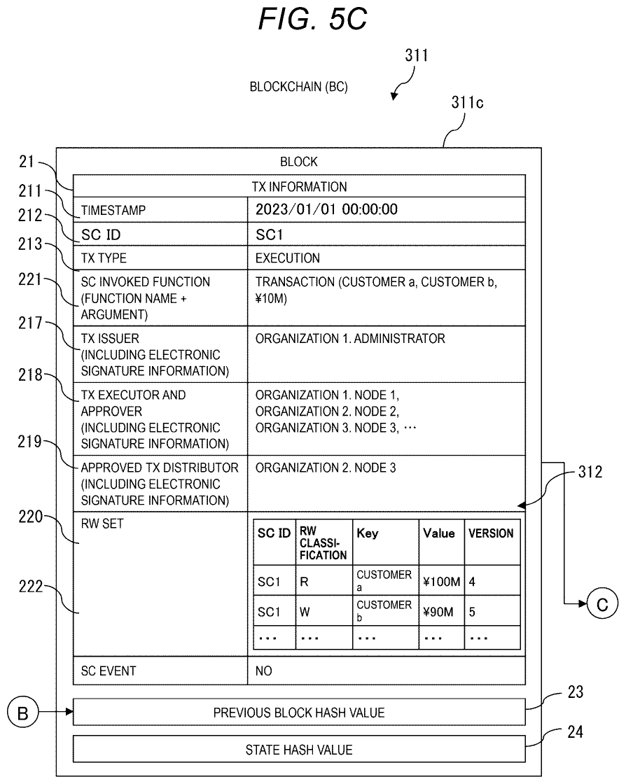

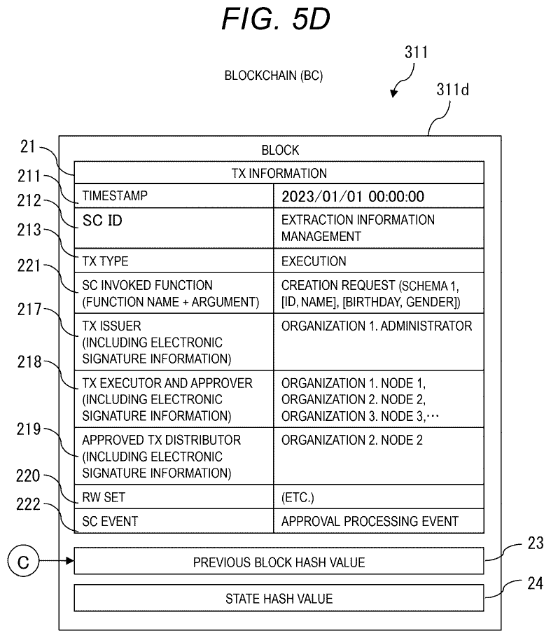

FIGS. 5A to 5D are examples of data structures of blocks (a series of four blocks) of the BC 311 in the distributed ledger DB 310 shown in FIG. 2. In the distributed ledger technology, a plurality of transactions are managed as blocks, and the BC 311 has a structure in which the blocks are chained such that each block contains a hash value of a previous block. According to the above structure, when even one bit of a value of a preceding block changes, hash values of all subsequent blocks change, making it difficult for a malicious actor or the like to tamper with a content.

In the present embodiment, a case where one transaction and one block correspond to each other on a one-to-one basis is shown as an example, and alternatively, a plurality of transactions may correspond to one block. The BC 311 shown in FIGS. 5A to 5D has a configuration in which smart contracts are linked as the single BC 311, and the BC 311 may have another configuration as long as each participating organization is accessible. In addition, with respect to the smart contract, a plurality of smart contracts may be individually defined, or a plurality of smart contracts may be consolidated and defined as a single smart contract.

Blocks 311a to 311d shown in FIGS. 5A to 5D include information on TX information 21, a previous block hash value 23, and a state hash value 24 (a hash value generated from state information to be described later).

The block 311a shown in FIG. 5A includes information on a transaction for deploying the business SC 313 whose identifier (hereinafter, referred to as a “SC_ID”) is “SC1” (hereinafter, referred to as a “deployment TX”). The block 311b shown in FIG. 5B includes information on a deployment TX of the extraction information management SC 314.

The block 311c shown in FIG. 5C includes information on a transaction for executing the business SC deployed by the deployment TX of the block 311a shown in FIG. 5A (hereinafter, referred to as an “execution TX”). The block 311d shown in FIG. 5D includes information on the execution TX of the business SC deployed by the deployment TX of the block 311b shown in FIG. 5B.

The block 311a shown in FIG. 5A includes information on the deployment TX of the business SC 313 whose identifier (hereinafter referred to as a “SC_ID”) is “SC1”. The business SC 313 is, for example, a smart contract of a business related to a business contract in a commercial transaction (a virtual currency transaction between organizations such as companies).

As shown in the FIG. 5A, the TX information 21 of the block 311a includes items of a timestamp 211, an SC_ID 212, a TX type 213, an SC entity 214, an SC input specification 215, an SC meta definition 216, a TX issuer 217, a TX executor and approver 218, an approved TX distributor 219, and an RW set 220.

Among these, the timestamp 211 stores date and time (timestamp) when the transaction is issued.

The SC_ID 212 stores the SC_ID of the business SC 313.

The TX type 213 stores information indicating a type of the transaction (a “deployment TX”, an “execution TX”, in addition, a transaction for referring to information in the BC 311 (hereinafter referred to as a “reference TX”), or the like).

The SC entity 214 stores an entity (for example, executable binary data (execution code)) of the business SC 313.

The SC input specification 215 stores information for a user to grasp a function name and an argument thereof in the smart contract. In the shown block 311a, the business SC 313 including at least the following functions (hereinafter referred to as “SC functions”) is defined.
Function name: transaction ( ), input argument: sender customer ID, receiver customer ID, amount
Function name: transaction reference ( ), input argument: customer ID, transaction ID, return value: transaction ID list

The SC meta definition 216 stores a parameter determined according to an input argument specified when the smart contract is deployed. The parameter is, for example, a consensus condition (such as acceptance of a transaction in response to approvals from more than half of the participating organizations) at the time of execution of the smart contract, or various types of other definition information.

The TX issuer 217 stores information on an issuer of the transaction (for example, an identifier of the issuer (for example, the client node 4, the distributed ledger node 3, an administrator, or a user) (hereinafter, referred to as a “member ID”)), and information on an electronic signature (for example, a verifiable credential used for verifying the issuer or whether data is tampered with). The electronic signature is performed using a secret key of each member issued by the member management unit 350, and is verified using a public key (verifiable credential) of the secret key.

Similarly to the TX issuer 217, the TX executor and approver 218 stores information on a participant involved in consensus formation or a smart contract executed by the consensus management unit 325 or the SC execution management unit 330 (hereinafter, referred to as a “TX executor and approver”) (information on a participant related to consensus formation or SC execution processing by the consensus management unit 325 or the SC execution management unit 330).

The approved TX distributor 219 stores information on a participant involved in distribution processing by the approved TX distribution unit 335 (hereinafter, referred to as an “approved TX distributor”).

The RW set 220 stores information referred to or information updated in processing executed for the transaction (hereinafter referred to as an “RW set” (RW: read-write)).

The block 311c shown in FIG. 5C is an execution TX for invoking (executing) the business SC 313 deployed by the deployment TX of the block 311a shown in FIG. 5A.

As shown in the FIG. 5C, TX information of the shown block 311c includes items of the timestamp 211, the SC_ID 212, the TX type 213, invoked function and input argument 221, the TX issuer 217, the TX executor and approver 218, the approved TX distributor 219, an RW set 220, and an SC event 222. Among the above items, the timestamp 211, the SC_ID 212, the TX issuer 217, the TX executor and approver 218, and the approved TX distributor 219 are the same as those in the block 311a in FIG. 5A, and description thereof is omitted.

The TX type 213 stores “execution” when processing executed by the execution TX includes update processing of the distributed ledger DB 310, and stores “reference” when the processing executed by the execution TX is reference processing including no update processing of the distributed ledger DB 310. In this example, “execution” is stored in the TX type 213.

The invoked function and input argument 221 stores an SC function invoked by the smart contract and an input argument provided to the SC function. In this example, the invoked function and input argument 221 stores “transaction ( )” as the SC function and an input argument “customer a, customer b, ¥10M”.

The RW set 220 stores information (RW set) that is referred to or updated in the processing executed for the transaction. In this example, the RW set 220 stores information referred to or information updated when the smart contract is deployed or executed. The RW set corresponds to the state information described above.

In the shown block 311c, the RW set 220 stores, as an RW set, a table having one or more records which have items of an SC_ID 2201, RW classification 2202, a Key 2203, a Value 2204, and a version 2205.

Among the above items, the SC_ID 2201 stores an identifier of the smart contract (SC_ID).

The RW classification 2202 stores information indicating whether the SC_ID is referred to (Read) or updated (Write) (hereinafter referred to as “RW classification”).

The Key 2203 and the Value 2204 store information referred to or updated by the smart contract specified by the SC_ID.

The version 2205 stores information indicating a version of the above information corresponding to a combination of the SC_ID and the Key. The version is incremented by one each time the information is updated, for example.

As shown in the FIG. 5C, information indicating that “registration (customer a, customer b, ¥10M)”, which is an SC function of the smart contract, is executed, a Value “¥100M” of a version number “4” is acquired with reference to a Key “customer a” (first line), and the version number is updated to “5” as a result of updating with a Value “¥90M” is managed as an RW set.

As described above, a transaction execution result is managed as the RW set (state information). Therefore, by referring to the RW set, the transaction execution result can be directly acquired without executing the smart contract. Accordingly, for example, it is possible to efficiently share the transaction execution result among the plurality of distributed ledger nodes 3 including the distributed ledger node 3 that does not execute the smart contract.

The SC event 222 shown in the same figure stores information (hereinafter, referred to as “event information”) on an event (hereinafter, referred to as an “SC event”) generated by the distributed ledger node 3 (smart contract). The TX management unit 320 of the distributed ledger node 3 generates the event information at a timing when a transaction history is added to the BC 311 of the distributed ledger DB 310 or the like, and stores the generated event information in the SC event 222.

The client node 4 or the distributed ledger node 3 participating in the distributed ledger system 1 can refer to the event information stored in the SC event 222 of the BC 311 via the communication network 5. That is, the event information can be shared between distributed ledger nodes 3 and between each distributed ledger node 3 and each client node 4 via the SC event 222. The distributed ledger node 3 and the client node 4 can execute various types of processing according to the event information.

The block of the deployment TX of the business SC 313 (block 311a shown in FIG. 5A) and the block of the execution TX of the business SC 313 (block 311c shown in FIG. 5C) are described above, and a block of the deployment TX of the extraction information management SC 314 (block 311b shown in FIG. 5B) and a block of an execution TX of the extraction information management SC 314 (block 311d shown in FIG. 5D) have the same configuration. In this way, the blocks of the business SC 313 and the extraction information management SC 314 are common, and thus functions of the distributed ledger node 3 for processing both can be shared. Therefore, a mechanism of the present embodiment can be efficiently implemented.

### State Information

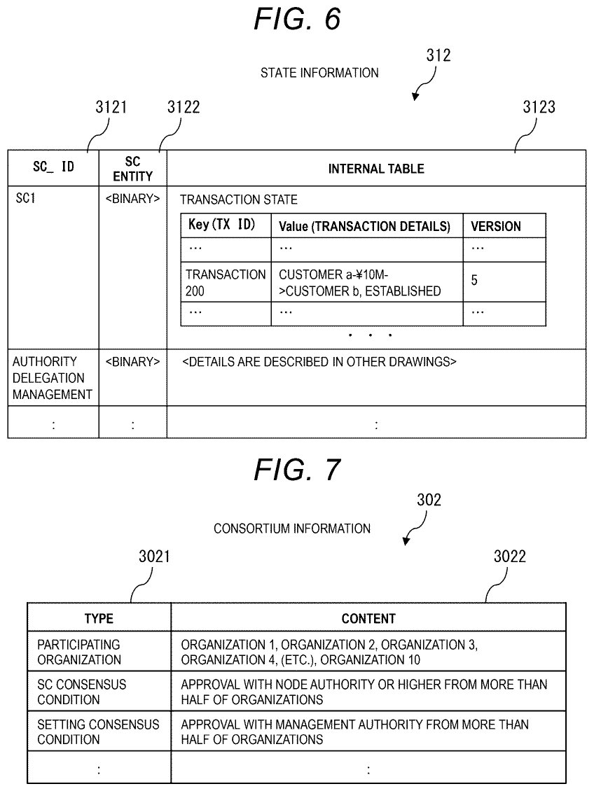

FIG. 6 is an example of a data structure of the state information 312. In a mechanism of information management by a BC, it is necessary to sequentially traverse the BC in order to acquire a latest state of information managed by the BC (for example, a latest balance of a virtual currency when the virtual currency is managed on the BC), which is inefficient. In the present embodiment, a mechanism is adopted in which a latest state of the information managed on the BC, which is acquired by reflecting all contents of the RW set described above, is managed as the state information 312. A mechanism similar to the above-described mechanism is disclosed in, for example, “Hyperledger Fabric”, [online], [retrieved Mar. 7, 2024], Internet hyperledger-fabric.readthedocs.io/en/latest/.

In the present embodiment, the SC execution management unit 330 acquires an entity of the smart contract using the SC_ID as a key and executes the smart contract, and the state information 312 is managed for each smart contract (a data storage area is prepared).

As shown in the FIG. 6, the illustrated state information 312 includes one or more records having items of an SC_ID 3121, an SC entity 3122, and an internal table 3123.

Among these, the SC_ID 3121 stores the SC_ID of the smart contract. The SC entity 3122 stores the entity of the smart contract (for example, executable binary data (execution code)). Accordingly, the SC execution management unit 330 can acquire and execute the entity of the smart contract using the SC_ID as a key.

The internal table 3123 manages information used at the time of SC execution, such as an execution result of the smart contract. A content of the internal table 3123 is updated each time a transaction is executed. In this example, a latest value of the RW set stored in the RW set 220 is managed in the internal table 3123.

In this example, information is stored in the internal table 3123 in a key-value format, and the value may be stored in the internal table 3123 in another format such as a JavaScript Object Notation (JSON) (“Java” and “JavaScript” are both registered trademarks) format. For example, the information may be stored in the internal table 3123 as a table of any data schema. By devising key design, it is possible to virtually manage a plurality of pieces of information having different schemas in the internal table 3123. In the present embodiment, with respect to the internal table 3123 related to the extraction information management SC 314, a case where structured data is stored in Value is shown as an example, and description of a Key-Value-version or the like is omitted.

In the distributed ledger system 1, when a transaction is added to the distributed ledger, the client node 4 of each participating organization can be notified of an event. Each participating organization can execute processing corresponding to the event that is notified of. The SC event 222 in FIGS. 5C and 5D stores event information on the event.

### Consortium Information

FIG. 7 is an example of the consortium information 302 shown in FIG. 2. The consortium information 302 includes the information on the participating organizations, information on the consensus condition for accepting a transaction related to execution of a smart contract, the consensus s condition for accepting a transaction for changing distributed ledger network setting, and the like.

As shown in the FIG. 7, the shown consortium information 302 includes a plurality of records having items of a type 3021 and a content 3022. The type 3021 stores information indicating an information type, and the content 3022 stores a content corresponding to the information type stored in the type 3021.

As shown in the FIG. 7, in the shown consortium information 302, information corresponding to each type of “participating organization”, “SC consensus condition”, and “setting consensus condition” is stored in the content 3022.

Among these, in the content 3022 of a record in which the type 3021 is “participating organization”, a list of participating organizations (“organization 1, organization 2, organization 3, organization 4 ( . . . ), organization 10”) of the distributed ledger network (consortium) is stored in the content 3022.

The content 3022 of the type 3021 of “SC consensus condition” stores “approval with node authority or higher from more than half of organizations” as the SC consensus condition (the consensus condition for accepting the transaction related to execution of the smart contract) described above.

The content 3022 of the type 3021 of “setting consensus condition” stores “approval with management authority from more than half of organizations” as a consensus formation condition necessary for changing setting of the distributed ledger system 1 (hereinafter, referred to as “setting consensus condition”).

This is merely an example of the consensus condition shown in the figure. For example, the consensus condition may specify the number of organizations such as “approvals with management authority from three or more organizations”. In addition, the consensus condition may be a complicated condition combining various conditions such as “approval from specific organization (for example, “organization 1”) is essential and approval from one or more organizations other than specific organization is required”.

### Extraction Information Management SC

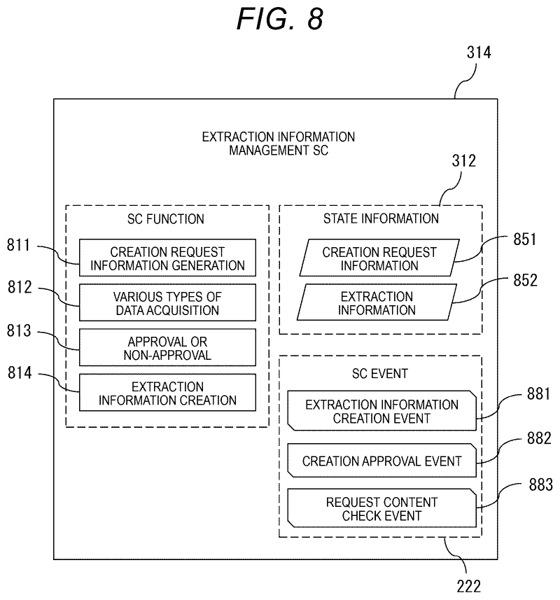

FIG. 8 shows the extraction information management SC 314 shown in FIG. 2. As shown in the FIG. 8, the extraction information management SC 314 includes various SC functions (creation request information generation 811, various types of data acquisition 812, an approval or non-approval 813, and extraction information creation 814). During execution, the SC function accesses the state information 312 and the SC event 222 of the BC 311 to update or refer to the BC 311 and an SC event content.

Among the SC functions, the creation request information generation 811 executes processing related to generation of creation request information that is information for obtaining consensus from each organization in response to a creation request for extraction information.

The various types of data acquisition 812 executes processing of acquiring various types of information managed in the distributed ledger DB 310 when an approval or non-approval of the creation request is determined based on the creation request information.

The approval or non-approval 813 executes processing related to determination of the approval or non-approval of the creation request information.

The extraction information creation 814 executes processing related to creation of extraction information.

As shown in the FIG. 8, the state information 312 includes creation request information 851 and extraction information 852.

The creation request information 851 is the above-described creation request information. The creation request information 851 is referred to or updated during consensus formation between the participating organizations regarding the creation of the extraction information.

The extraction: information 852 is the above-described extraction information, and is referred to or updated when information to be stored in the BC 311 is extracted from the VC.

As shown in the FIG. 8, the SC event 222 includes an extraction information creation event 881, a creation approval event 882, and a request content check event 883. These events are notified to the distributed ledger node 3 and the client node 4 from time to time.

For example, the distributed ledger node 3 executes processing related to creation of the extraction information 852 upon receiving the extraction information creation event 881.

For example, the distributed ledger node 3 executes, upon receiving the creation approval event 882, processing related to consensus formation between the participating organizations regarding the creation of the extraction information 852.

For example, the distributed ledger node 3 executes processing related to checking a content of the creation request information 851 upon receiving the request content check event 883.

### Creation Request Information

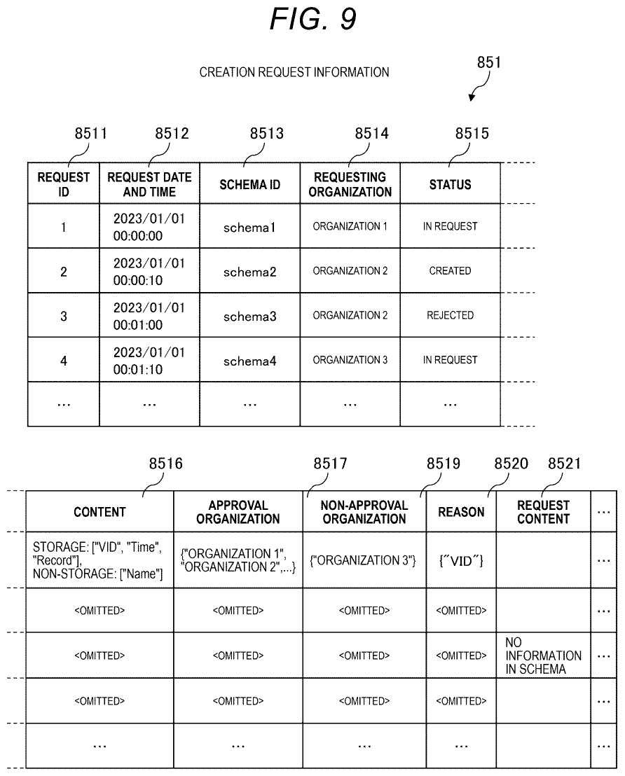

FIG. 9 is an example of a data structure of the creation request information 851. The creation request information 851 is generated based on information described in the schema (hereinafter referred to as “schema information”).

As shown in the FIG. 9, the shown creation request information 851 includes one or more records having items such as a request ID 8511, a request date and time 8512, a schema ID 8513, a requesting organization 8514, a status 8515, a content 8516, an approval organization 8517, a non-approval organization 8519, a reason 8520, and a request content 8521.

The request ID 8511 stores a “request ID” that is an identifier of the creation request received by the distributed ledger node 3.

The request date and time 8512 stores date and time when the distributed ledger node 3 receives the creation request.

The schema ID 8513 stores a “schema ID” that is an identifier of the schema used to create the extraction information. The schema ID 8513 is used, for example, when verifying the VC.

The requesting organization 8514 stores an “organization ID” that is an identifier of a requesting organization (a participating organization that executes (launches) the creation request information generation 811).

The status 8515 stores information indicating a current state of the creation request. In this example, any one of “in request”, “rejected”, and “created” is stored. For example, when the creation request is “approved”, a content of the status 8515 changes from “in request” to “created”. When the creation request is “not approved”, the status 8515 changes from “in request” to “rejected”.

The content 8516 stores information indicating what information in the schema information is to be stored in the BC 311. An organization that determines an approval or non-approval for the creation request checks the content 8516 and the schema information, and then executes processing for the approval or non-approval.

The approval organization 8517 stores an organization ID of an organization that determines an “approval” for the creation request.

A non-approval organization 8518 is information indicating an organization ID of an organization that determines a “non-approval” for the creation request.

The reason 8520 stores information indicating a reason for the non-approval. For example, if the request ID 8511 in the figure is a record of “1”, the reason 8520 stores a reason such as “‘VID’ is set as the extraction target in the content but “organization 3” stored in the non-approval organization states that “VID” is not to be the extraction target”.

The request content 8521 stores, when there is a deficiency in the creation request, a reason therefor and information necessary for resolving the deficiency.

### Extraction Information

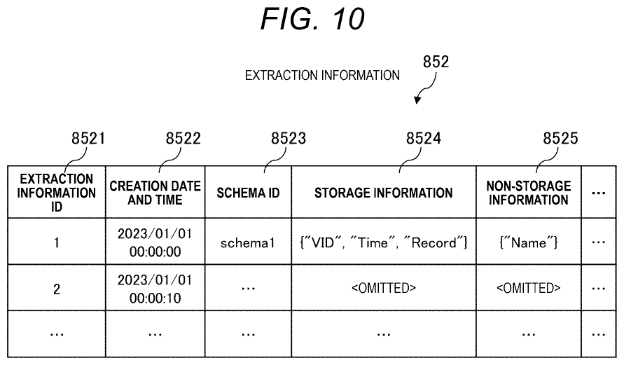

FIG. 10 is an example of a data structure of the extraction information 852 of the state information 312. The extraction information 852 is created based on the creation request information 851 when the number of a approvals exceeds predetermined (preset) number. The extraction information 852 is referred to when the BC storage information extraction unit 436 of the SSI application 410 extracts, from the VC, information to be stored in the BC. The Issuer creates the VC using the schema and the credential definition, and thus creates the extraction information 852 based on schema information, thereby enabling correct extraction of information in the VC.

As shown in the FIG. 10, the shown extraction information 852 includes one or more records having items such as an extraction information ID 8521, a creation date and time 8522, a schema ID 8523, storage information 8524, and non-storage information 8525.

Among these, the extraction information ID 8521 stores an extraction information ID that is an identifier of the extraction information 852.

The creation date and time 8522 stores date and time when the extraction information 852 is created.

The schema ID 8523 stores a schema ID of the schema used to extract the extraction information 852.

The storage information 8524 stores information for specifying information that is extracted from the VC and to be stored in the BC 311 (hereinafter referred to as “storage information”).

The non-storage information 8525 stores information for specifying information not to be stored in the BC 311 (hereinafter referred to as “non-storage information”).

### SC Deployment and Execution

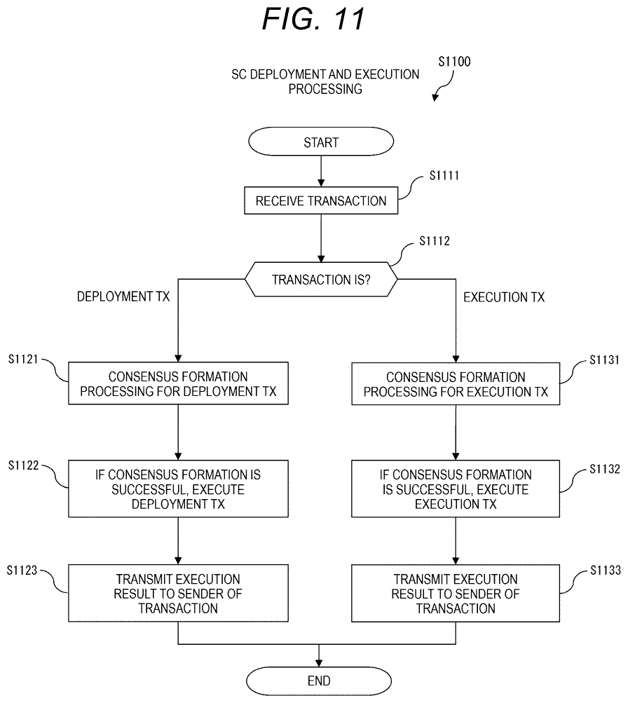

FIG. 11 is a flowchart showing processing executed by the distributed ledger node 3 when the smart contract is deployed or executed in the distributed ledger DB 310 of the distributed ledger node 3 (hereinafter, referred to as “SC deployment and execution processing S1100”). Hereinafter, the SC deployment and execution processing S1100 will be described with reference to the figure.

First, the TX management unit 320 receives a transaction for deploying or executing the smart contract from another information processing apparatus such as the client node 4 (S1111).

Subsequently, the consensus management unit 325 of the distributed ledger node 3 determines a transaction type (in this example, a “deployment TX” or “execution TX”) of the received transaction (S1112). If the received transaction is a “deployment TX” (S1112: deployment TX), the processing proceeds to S1121. If the received transaction is an “execution TX” (S1112: execution TX), the processing proceeds to S1131.

In S1121, the consensus management unit 325 executes processing for consensus formation with another distributed ledger node 3 on execution of the received deployment TX and addition to the BC 311 (hereinafter, referred to as “consensus formation processing”) (S1121).

The consensus formation processing is executed using, for example, a well-known or established technology. For example, in an “Endorser-Orderer model” disclosed in NPL 3, consensus formation is executed through the following steps.

First, the consensus management unit 325 selects the distributed ledger node 3 having an approval authority from the distributed ledger nodes 3 (including itself) participating in the distributed ledger network, and shares the deployment TX with each selected distributed ledger node 3. Each selected distributed ledger node 3 verifies whether the shared deployment TX has any problem (verification of presence or absence of tampering, verification of presence or absence of authenticity, and the like).

The consensus management unit 325 acquires a verification result (“approval” or “non-approval”) from each selected distributed ledger node 3, compares the verification result of each distributed ledger node 3 with a predetermined consensus condition, and determines whether to accept the deployment TX. Then, the consensus management unit 325 transmits a determination result to all the distributed ledger nodes 3 participating in the distributed ledger network.

In the consensus formation according to such an “Endorser-Orderer model”, it is not necessary for all the distributed ledger nodes 3 participating in the distributed ledger network to verify the transaction, and thus the transaction can be efficiently verified.

When consensus is reached, subsequently, the approved TX distribution unit 335 broadcasts the deployment TX to all the distributed ledger nodes 3 participating in the distributed ledger network. The SC execution management unit 330 of the distributed ledger node 3 that receives the deployment TX executes the received deployment TX and deploys the smart contract related to the deployment TX in the distributed ledger DB 310 (S1122). The deployment is executed by storing an SC_ID and an entity of the smart contract as the state information 312 in the distributed ledger DB 310 based on a content of the deployment TX and adding a block of the deployment TX to the end of the BC 311.

Subsequently, the consensus management unit 325 transmits an execution result of the deployment TX to a sender of the deployment TX (S1123).

In S1131, the consensus management unit 325 executes the same consensus formation processing as that in S1121 for the execution TX. When consensus is reached, subsequently, the approved TX distribution unit 335 broadcasts the execution TX to all the distributed ledger nodes 3 participating in the distributed ledger network. The SC execution management unit 330 of the distributed ledger node 3 that receives the execution TX executes the smart contract specified by the execution TX (S1132). The execution of the smart contract is performed by specifying a function to be invoked, which is specified in the execution TX, and providing an input argument to the smart contract specified in the execution TX. By executing the smart contract, a content of the distributed ledger DB 310 is updated, and a block of the execution TX is added to the end of the BC 311.

Subsequently, the consensus management unit 325 of the distributed ledger node 3 transmits an execution result of the execution TX to a sender of the execution TX (S1133).

### Creation Request Information Generation

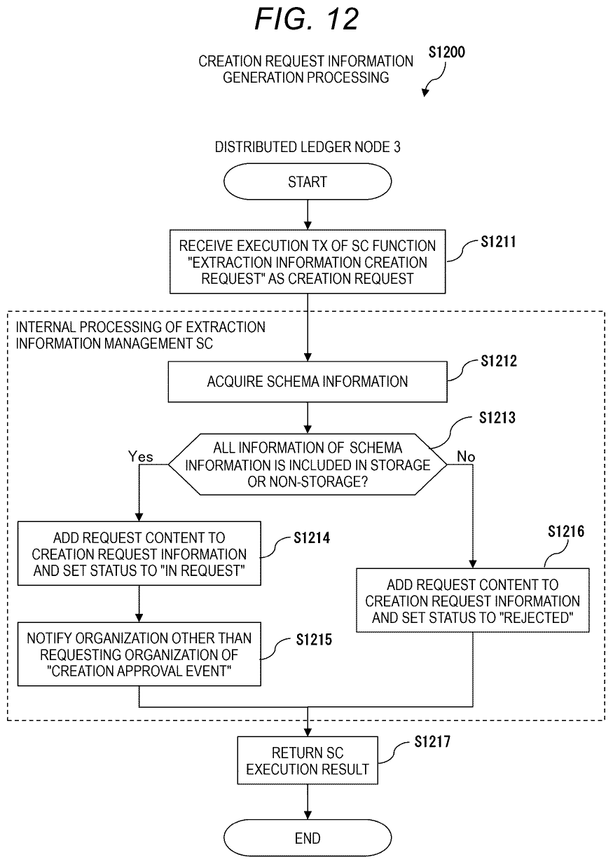

FIG. 12 is a flowchart showing processing executed by the SC function “creation request information generation 811” of the extraction information management SC 314 (hereinafter, referred to as “creation request information generation processing S1200”).

The Issuer that is the requesting organization issues an execution TX of the SC function “creation request information generation 811” to a group of the distributed ledger nodes 3 using the client node 4 in order to create the extraction information 852 corresponding to the schema used when the Issuer itself issues the VC. For example, the Issuer issues the execution TX before issuing the VC to create the extraction information 852. Hereinafter, description will be given by focusing on one distributed ledger node 3 in the group.

As shown in the FIG. 12, first, the distributed ledger node 3 receives, from the client node 4, the execution TX of the SC function “creation request information generation 811” together with a creation request (S1211).

Subsequently, the distributed ledger node 3 acquires, from the distributed ledger DB 310, the schema information of the schema corresponding to the schema ID 8513 specified in the creation request (S1212).

Subsequently, the distributed ledger node 3 checks whether the acquired schema information includes storage information and non-storage information specified in the creation request (S1213).

When the schema information does not include the storage information and the non-storage information (that is, when there is a deficiency in the creation request) (S1213: No), the distributed ledger node 3 stores a content in the request content 8521 in the creation request information 851 and stores “rejected” in the status 8515 in the creation request information 851 (S1216).

On the other hand, when the schema information includes the storage information and the non-storage information (S1213: Yes), the distributed ledger node 3 sets a content of each item in the creation request information 851 based on the creation request. The status 8515 stores “in request” (S1214).

Subsequently, the distributed ledger node 3 of the requesting organization receiving the execution TX notifies the distributed ledger node 3 other than that of the requesting organization of the “creation approval event 882” (S1215). A request ID of the creation request is attached to the “creation approval event 882”.

After the processing in S1215 or S1216, the distributed ledger node 3 transmits information on an execution result (“in request”, “rejected”, or the like) of the creation request information generation processing S1200 to the client node 4 of the requesting organization (S1217).

As described above, the creation request information 851 is generated based on the schema information acquired in S1212, and for example, when the credential definition stored in the distributed ledger DB 310 includes information equivalent to the schema information, the creation request information 851 may be generated based on the credential definition. When the creation request information 851 is generated based on the credential definition, the extraction information may be generated for each credential definition, not for each schema. In this case, for example, an item of an identifier of the credential definition (hereinafter, referred to as a “credential definition ID”) is provided in the creation request information 851, and the credential definition ID of the credential definition used for generating the creation request information 851 is stored in the creation request information 851.

### Approval or Non-Approval Processing

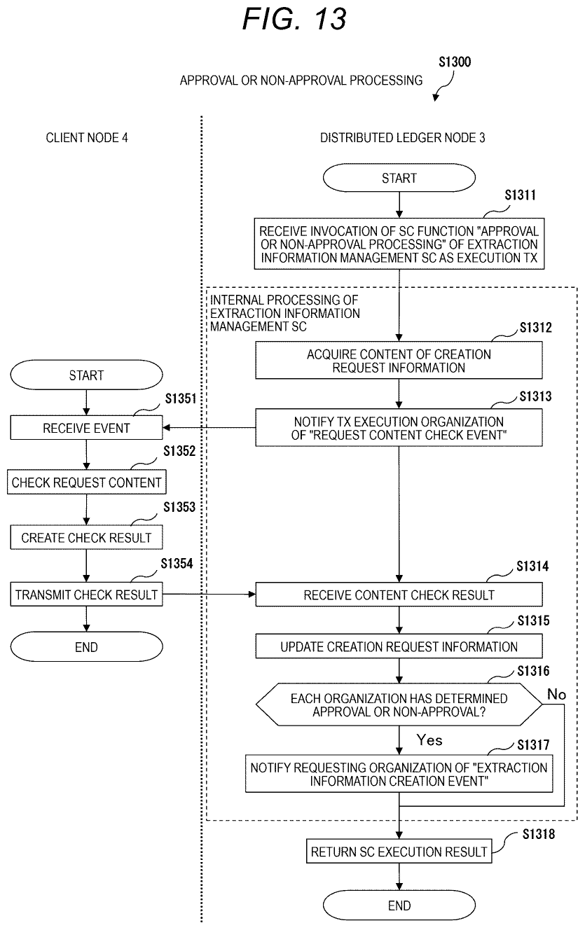

FIG. 13 is a flowchart showing an example of processing according to the SC function “approval or non-approval 813” of the extraction information management SC 314 (hereinafter, referred to as “approval or non-approval processing S1300”).

The approval or non-approval processing S1300 is triggered when the “creation approval event 882” is received from the distributed ledger node 3 of the requesting organization in S1215 of the creation request information generation processing S1200 and is executed by a participating organization other than the requesting organization by issuing the execution TX of the SC function “approval or non-approval 813” to each distributed ledger node 3 using each client node 4. Hereinafter, description will be given by focusing on one of the distributed ledger nodes 3.

First, the distributed ledger node 3 receives the execution TX from the client node 4 and starts the approval or non-approval processing S1300 (S1311).

Subsequently, the distributed ledger node 3 acquires, from the creation request information 851, information corresponding to the request ID attached to the “creation approval event 882” that is notified of (S1312).

Subsequently, the distributed ledger node 3 notifies the client node 4 of the “request content check event 883” to which the acquired information is attached (S1313).

Upon receiving the “request content check event 883” (S1351), the client node 4 presents the information attached to the received “request content check event 883”, receives determination of an approval or non-approval, and transmits a result of the received determination of the approval or non-approval as a check result to the distributed ledger node 3 (S1352 to S1354). At this time, the client node 4 may receive a reason for the determination of the approval or non-approval and add the received reason to the check result. The reason can be expected to improve accuracy of the creation request, for example, by presenting the reason to a participating organization as reference information when the participating organization that creates the creation request issues the creation request again or when another participating organization determines the approval or non-approval.

When checking the request content in S1352, the schema information may be presented to the participating organization. When the creation request information 851 is generated based on the credential definition instead of the schema, information on the credential definition instead of the schema is presented to the participating organization.

The distributed ledger node 3 receives the check result transmitted from the client node 4 (S1314) and updates the content of the creation request information 851 (the approval organization 8517, the non-approval organization 8519, and the reason 8520) to a latest state based on the received check result (S1315).

Subsequently, the distributed ledger node 3 checks whether all organizations other than the requesting organization have determined the approval or non-approval based on the creation request information 851 (S1316). When all the organizations other than the requesting organization have determined the approval or non-approval (S1316: Yes), the distributed ledger node 3 notifies the client node 4 of the requesting organization of the “extraction information creation event 881” (S1317).

After the “extraction information creation event 881” is notified of, the distributed ledger node 3 transmits an execution result of the SC function “approval or non-approval 813” to the requesting organization (S1318).

As described above, the distributed ledger system 1 creates the extraction information after checking the approval or non-approval determination result from each participating organization, and thus, for example, it is possible to prevent confidential information in the VC from being erroneously stored in the BC 311.

### Extraction Information Creation Processing

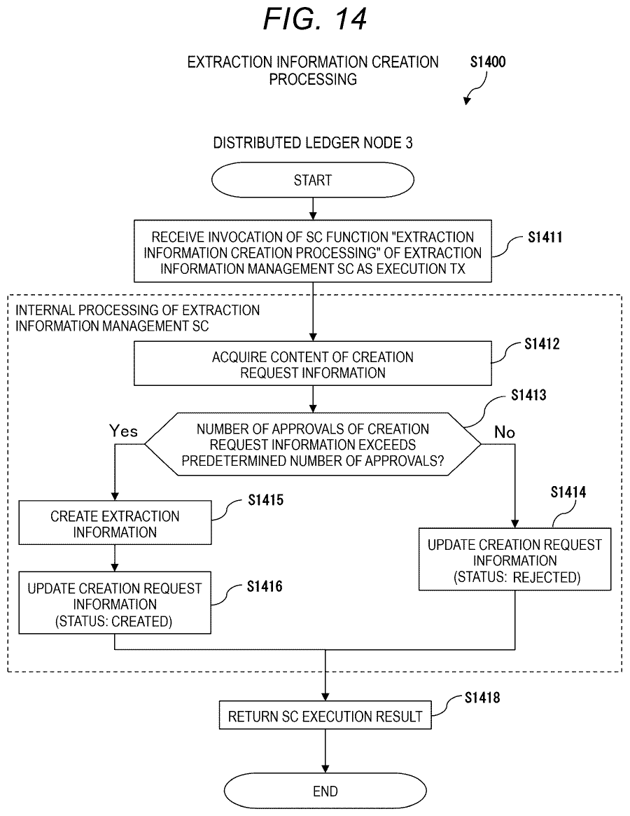

FIG. 14 is a flowchart showing an example of processing according to the SC function “extraction information creation 814” of the extraction information management SC 314 (hereinafter, referred to as “extraction information creation processing S1400”).

The extraction information creation processing S1400 is executed when the requesting organization issues the execution TX of the SC function “extraction information creation 814” to a group of distributed ledger nodes 3 using the client node 4 according to the “extraction information creation event 881” notified of in S1318 in FIG. 13 (S1411). Hereinafter, description will be given by focusing on one of the distributed ledger nodes 3.

First, the distributed ledger node 3 acquires the content of the creation request information 851 (S1412).

Subsequently, the distributed ledger node 3 checks whether the number of approvals of the creation request information 851 (the total number of organizations stored in the approval organization 8517) exceeds a predetermined number of approvals (S1413).

When the number of approvals of the creation request information 851 does not exceed the predetermined number of approvals (S1413: No), the distributed ledger node 3 stores “rejected” in the status 8515 of the request ID of the corresponding creation request in the creation request information 851 (S1414). Thereafter, the processing proceeds to S1418.

On the other hand, when the number of approvals of the creation request information 851 exceeds the predetermined number of approvals (S1413: Yes), the distributed ledger node 3 creates the extraction information 852 based on the creation request information 851, stores the extraction information 852 as the state information 312 in the distributed ledger DB 310 (S1415), and stores “created” in the corresponding status 8515 in the creation request information 851 (S1416). Thereafter, the processing proceeds to S1418.

In S1418, an execution result of the SC function “extraction information creation 814” is transmitted to the client node 4. For example, a content of the reason 8520 in the creation request information 851 may be added to the execution result to enable reference by the requesting organization when issuing the creation request again.

Through the extraction information creation processing S1400, the extraction information 852 can be created with consensus from the participating organization. Even when the extraction information 852 is changed, it is possible to update the extraction information 852 after obtaining consensus from each participating organization by executing the extraction information creation processing S1400 in the same manner.

### BC Storage Information Creation

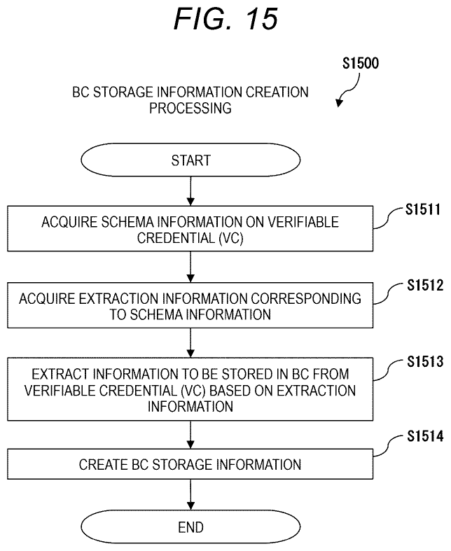

FIG. 15 is a flowchart showing an example of processing in which the SSI application 410 generates the BC storage information based on the VC created by the Issuer and the extraction information 852 created in the extraction information creation processing S1400 in FIG. 14 (hereinafter, referred to as “BC storage information creation processing S1500”). The BC storage information creation processing S1500 is executed when the Issuer issues the VC (S153 in FIG. 1B).

First, the SSI application 410 acquires schema information on the VC (S1511).

Subsequently, the SSI application 410 acquires the extraction information 852 corresponding to the acquired schema information from the distributed ledger DB 310 (S1512).

Subsequently, the SSI application 410 extracts information to be stored in the BC 311 (information used for creating the BC storage information) based on the VC and the extraction information 852 (S1513).

Subsequently, the SSI application 410 creates the BC storage information based on the extracted information (S1514).

As described above, only the storage information (the information specified in the storage information 8524 in the extraction information 852) is extracted from the VC to create the BC storage information, and for example, a content of non-storage information (information specified in the non-storage information 8525 in the extraction information 852) may be set to be unverifiable (for example, hashed) and then stored in the BC 311. In this way, correspondence between the VC and the information stored in the BC 311 can be verified, for example.

### User Interface

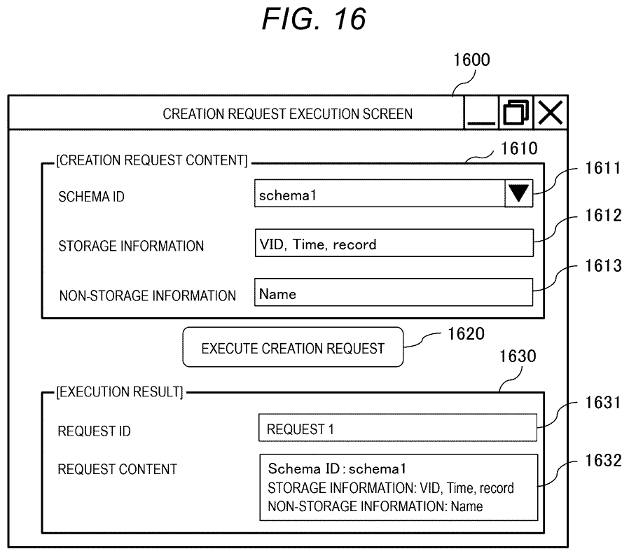

FIG. 16 is an example of a user interface provided by the SSI application 410, and is an example of a screen displayed by the SSI application 410 of the client node 4 when executing the extraction information creation processing S1400 in FIG. 14 (hereinafter, referred to as a “creation request execution screen 1600”). The creation request execution screen 1600 is displayed as, for example, a Web page on a screen of the client node 4.

As shown in the FIG. 16, the shown creation request execution screen 1600 includes a creation request content setting field 1610, a creation request execution button 1620, and an execution result display field 1630.

The creation request content setting field 1610 includes a schema ID setting field 1611, a storage information setting field 1612, and a non-storage information setting field 1613.

In the schema ID setting field 1611, the user inputs the schema ID of the schema stored in the BC 311. The schema ID setting field 1611 may be in a form of, for example, a combo box or a list box, and a list of schema IDs of schemas stored in the distributed ledger DB 310 may be displayed in a selectable state such that the user can select the schema ID from the list and input easily.

Information for specifying storage information is input to the storage information setting field 1612. Information for specifying non-storage information is input to the non-storage information setting field 1613. The storage information setting field 1612 and the non-storage information setting field 1613 may be in a form of, for example, a combo box or a list box, and a list of information extracted from the schema information of the schema stored in the distributed ledger DB 310 may be displayed in a selectable state such that the user can select the information for specifying the storage information or the information for specifying the non-storage information from the list and input easily.

When the user operates the creation request execution button 1620, the execution TX of the SC function “creation request information generation 811” to which the creation request including the request ID and a content set in the creation request content setting field 1610 is attached is transmitted to the distributed ledger node 3, and an execution result of the execution TX is displayed in the execution result display field 1630.

As shown in the FIG. 16, the execution result display field 1630 includes a creation request ID display field 1631 and a request content display field 1632. The creation request ID display field 1631 displays the request ID that is the identifier of the creation request. The request content display field 1632 displays information based on the creation request information 851.

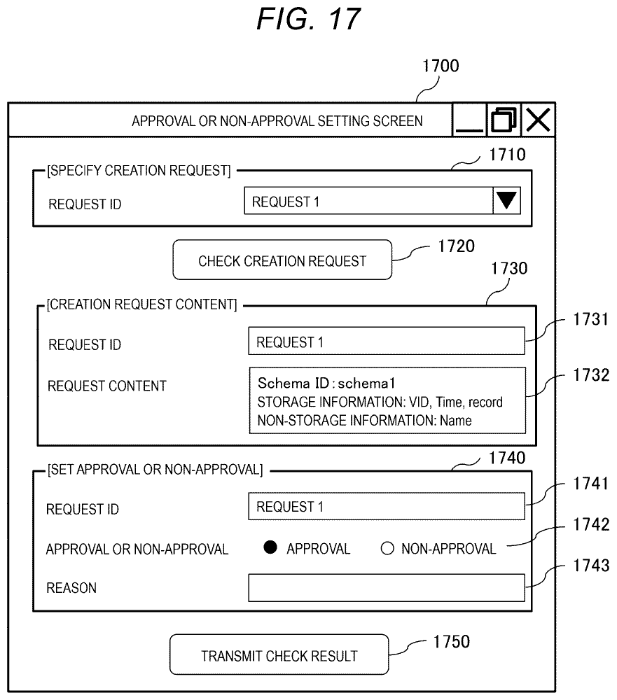

FIG. 17 is an example of a user interface provided by the SSI application 410, and is an example of a screen displayed by the SSI application 410 of the client node 4 when the “request content check event 883” is received in S1351 in FIG. 13 (hereinafter, referred to as an “approval or non-approval setting screen 1700”). The approval or non-approval setting screen 1700 is displayed as, for example, a Web page on the screen of the client node 4.

As shown in the FIG. 17, the shown approval or non-approval setting screen 1700 includes a creation request specifying field 1710, a creation request check button 1720, a creation request content display field 1730, an approval or non-approval setting field 1740, and a check result transmission button 1750.

In the creation request specifying field 1710, the user sets the request ID of the creation request that is a setting target of the approval or non-approval. For example, the creation request specifying field 1710 may be in a form of a combo box or a list box, and a list of request IDs in the creation request information 851 stored in the distributed ledger DB 310 may be displayed in a selectable state such that the user can select the request ID from the list and input easily.

When the creation request check button 1720 is operated, the request ID set in the creation request specifying field 1710 is transmitted to the distributed ledger node 3, and the content of the creation request information 851 corresponding to the request ID is returned from the distributed ledger node 3.

The creation request content display field 1730 includes a request ID display 1731 and a request content display field 1732. The request ID display 1731 displays the request ID set in the creation request specifying field 1710. The request content display field 1732 displays the content of the creation request information 851 returned from the distributed ledger node 3.

The approval or non-approval setting field 1740 includes a request ID display field 1741, an approval or non-approval selection field 1742, and a reason setting field 1743. The request ID display field 1741 displays the request ID set in the creation request specifying field 1710. The user sets whether the creation request is approved or not approved in the approval or non-approval selection field 1742. In the reason setting field 1743, a reason why the user approves or does not approve the creation request is input.

When the user operates the check result transmission button 1750, a content in the approval or non-approval setting field 1740 is transmitted to the distributed ledger node 3 (S1354 in FIG. 13).

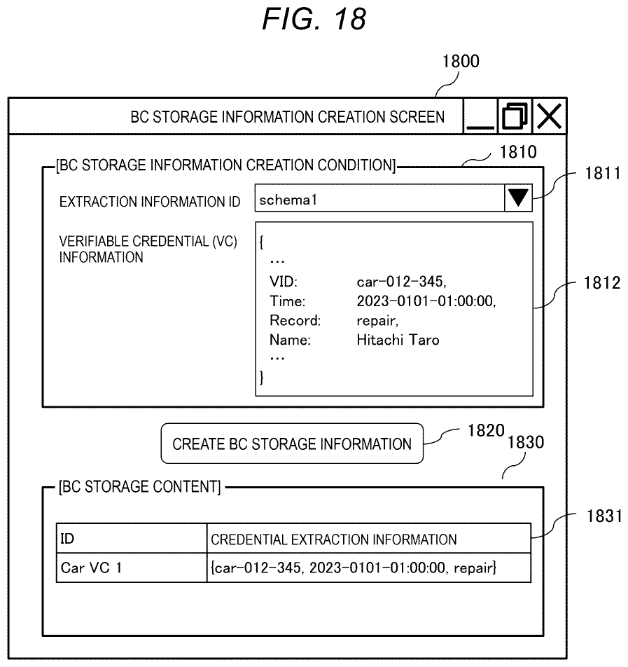

FIG. 18 is an example of a screen displayed by the client node 4 when the BC storage information creation processing S1500 in FIG. 15 is executed (hereinafter referred to as a “BC storage information creation screen 1800”). The BC storage information creation screen 1800 is displayed as, for example, a Web page on the screen of the client node 4. The BC storage information creation screen 1800 is displayed by the client node 4 of the Issuer when the Issuer issues the VC (S153 in FIG. 1B).

As shown in the FIG. 18, the shown BC storage information creation screen 1800 includes a BC storage information creation condition setting field 1810, a BC storage information creation button 1820, and a BC storage content display field 1830.

The BC storage information creation condition setting field 1810 includes an extraction information ID setting field 1811 and a verifiable credential (VC) information setting field 1812.

The user sets the extraction information ID of the created extraction information 852 (the schema ID of the schema related to the VC) in the extraction information ID setting field 1811. The extraction information ID setting field 1811 may be in a form of, for example, a combo box or a list box, a list of extraction request IDs in the extraction information 852 stored in the distributed ledger DB 310 may be displayed in a selectable state such that the user can select the extraction information ID from the list and input easily.

A content of the VC is set in the VC information setting field 1812.

When the BC storage information creation button 1820 is operated, the BC storage information is created by the BC storage information creation processing S1500.

The BC storage content display field 1830 displays the created BC storage information. The figure shows an example in which, among the information “VID, Time, Record, Name” of the VC in the extraction information 852, “VID, Time, Record” is the storage information, and “Name” is the non-storage information.

### Technical Effects

As described above, the extraction information 852 is created with consensus from the participating organizations and the BC storage information is created based on the created extraction information 852, and thus the distributed ledger system 1 can safely store the information extracted from the VC in the BC 311. Therefore, it is possible to prevent leakage of information using the SSI technology and to ensure traceability of information exchanged (transacted) when using the SSI technology.

The above mechanism can be widely applied not only to traceability using the BC 311 but also to a case where it is necessary to link information handled by the SSI technology with the information stored in the BC 311.

Here, for example, in a case where a plurality of organizations of different industry types participate as participating organizations, it is difficult to determine whether each organization may use schema information of a different industry type as the storage information in the BC 311. Therefore, the participating organizations may be divided into groups in a range in which the above determination can be made, and whether the extraction information 852 can be created may be determined with consensus within the range of each group.

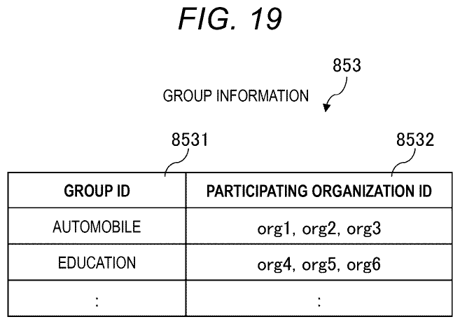

FIG. 19 is an example of information for managing the group (hereinafter referred to as “group information 853”). The group information 853 is managed as, for example, the state information 312 in the distributed ledger DB 310. The group information 853 is set, for example, via the user interface of the client node 4.

The shown group information 853 includes information in which a participating organization ID that is an identifier of a participating organization is associated with each group ID that is an identifier of the group. In this case, a condition for determining whether consensus is reached may be set for each group, or a condition set for all participating organizations may be inherited. For example, when “the number of approvals is ⅔ or more of all participating organizations” is set as the condition for all participating organizations, a condition of each group is “the number of approvals is ⅔ or more of participating organizations in the group”.

### Second Embodiment

In the first embodiment, the BC storage information is created based on the verifiable credential (VC) created by the credential issuing organization (Issuer) and is stored in the BC 311 (S153 in FIG. 1B), and in the second embodiment, when the credential holder (Holder) hands the verifiable presentation (VP) over to the verifier (Verifier), BC storage information is created based on the VP and stored in the BC 311.

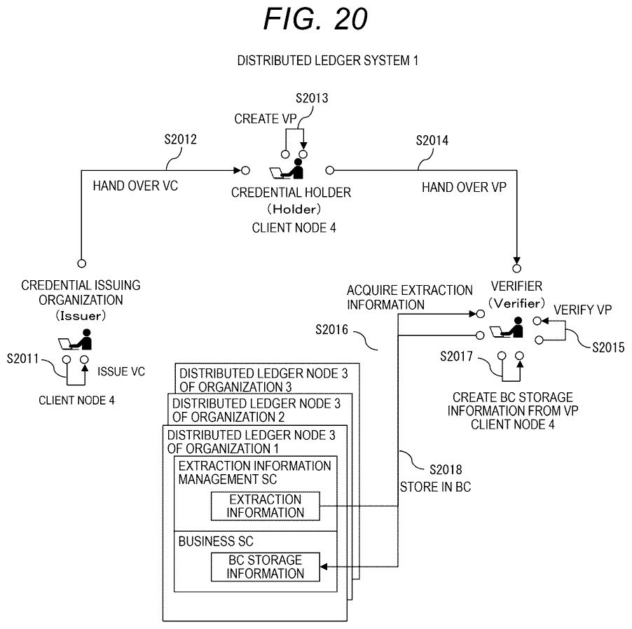

FIG. 20 shows a flow from when the VC is issued by the Issuer to when the VP is verified by the Verifier in the second embodiment. It is assumed that the extraction information 852 has already been created by the method described in the first embodiment.

First, the Issuer issues the VC (S2011) and hands the VC over to the Holder (S2012). Unlike FIG. 1B, the Issuer may not create the BC storage information.

After confirming that the VC handed over is correct, the Holder creates the VP including only information required by the Verifier (S2013), and hands the created VP over to the Verifier (S2014).

When the Verifier confirms t that the VP handed over is correct (S2015), the extraction information 852 is acquired (S2016), the BC storage information is created by extracting information from the VP based on the acquired extraction information 852 (S2017), and the created BC storage information is stored in the BC 311 (S2018).

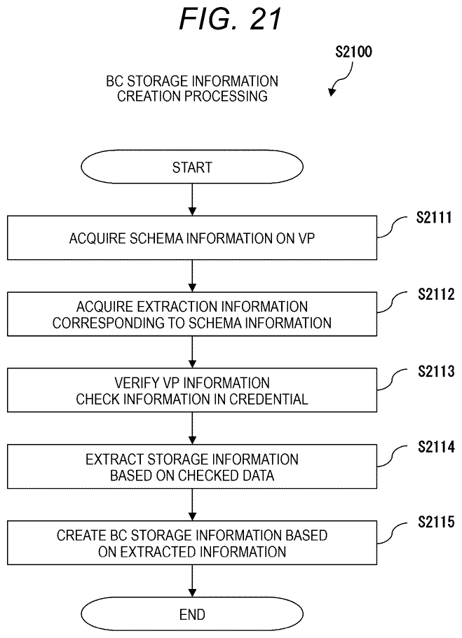

FIG. 21 shows an overview of a flow (S2015 to S2017) from verification of the VP shown in FIG. 20 to creation of the BC storage information.

First, the Verifier acquires schema information corresponding to the VP (S2111) and acquires the extraction information 852 corresponding to the acquired schema information (S2112).

Subsequently, the Verifier verifies the VP and checks information in the VC (S2113).

Subsequently, the Verifier acquires information to be stored in the BC 311 based on the VP and the extraction information 852 (S2114) and creates the BC storage information based on the acquired information (S2115).

According to the mechanism in the second embodiment described above, when the Verifier verifies the VP, the BC storage information is created based on the VP and stored in the BC 311, and thus for example, an audit trail (history) indicating that the Verifier correctly performs verification can be left in the BC 311.

### Third Embodiment

In the above embodiments, only the information corresponding to the schema in the information of the VC is stored in the BC 311 as the BC storage information, and for example, unique information (hereinafter also referred to as a “unique ID”) may be assigned to the VC, and the unique ID may be stored in the BC 311 as the BC storage information. By including the unique ID assigned to the VC in the BC storage information, it is possible to easily correlate the VC with the BC storage information retrospectively, and thus checking and verification of the VC and the BC storage information can be efficiently executed.

The unique ID may be, for example, a transaction identifier (a transaction ID, hereinafter referred to as a “TX_ID”.) acquired in processing of checking whether the schema and the credential definition are correctly stored in the VDR, which is executed when the VC is issued in the SSI technology.

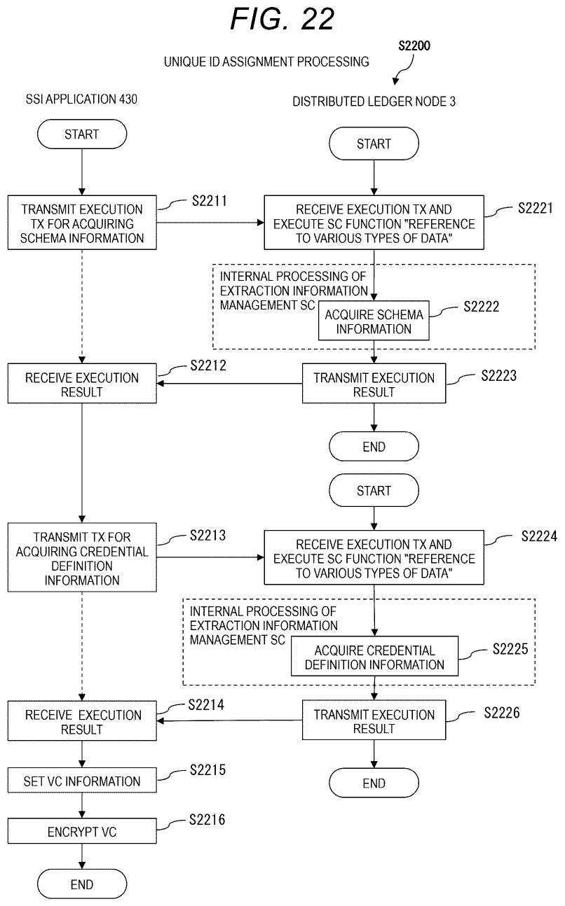

FIG. 22 is a flowchart showing processing of assigning the “TX_ID” acquired in the above processing as the unique ID to the VC (hereinafter referred to as “unique ID assignment processing S2200”).

First, the SSI application 410 transmits a transaction for acquiring the schema information (an execution TX of the SC function “various types of data acquisition 812”) to the distributed ledger node 3 (S2211). At this time, the SSI application 410 stores the “TX_ID” of the execution TX.

The distributed ledger node 3 receives the transaction, executes the SC function “various types of data acquisition 812” to acquire the schema information, and transmits the acquired schema information as an execution result to the SSI application 410 (S2221 to S2223). The “TX_ID” of the execution TX transmitted in S2211 may be attached to the execution result such that the SSI application 410 can specify which transaction the execution result corresponds to.

The SSI application 410 receives the schema information transmitted from the distributed ledger node 3 (S2212).

Subsequently, the SSI application 410 transmits a transaction for acquiring the credential definition information (the execution TX of the SC function “various types of data acquisition 812”) to the distributed ledger node 3 (S2211). At this time, the SSI application 410 stores the “TX_ID” of the execution TX.

The distributed ledger node 3 receives the transaction, executes the SC function “various types of data acquisition 812” to acquire the credential definition information, and transmits the acquired credential definition information as an execution result to the SSI application 410 (S2224 to S2226). The “TX_ID” of the execution TX transmitted in S2211 may be attached to the execution result such that the SSI application 410 can specify which transaction the execution result corresponds to.

The SSI application 410 receives the credential definition information sent from the distributed ledger node 3 (S2214).

Subsequently, the SSI application 410 receives a content of the VC from a user of the Issuer, adds at least one of the “TX_ID” stored in S2211 and the “TX_ID” stored in S2213 as the unique ID of the VC in the received content, and sets the content as the content of the VC (S2215).

Subsequently, the SSI application 410 encrypts the set content of the VC and issues the VC.

As described above, the “TX_ID” acquired in the processing of checking whether the schema and the credential definition are correctly stored in the VDR can be assigned to the VC as the unique ID. By storing the unique ID in the BC storage information, for example, at the time of creating the BC storage information, the VC and the BC storage information can be easily correlated, and a load when the user checks an audit trail (history) of the information exchanged in the SSI technology can be reduced.

### Example of Information Processing Apparatus

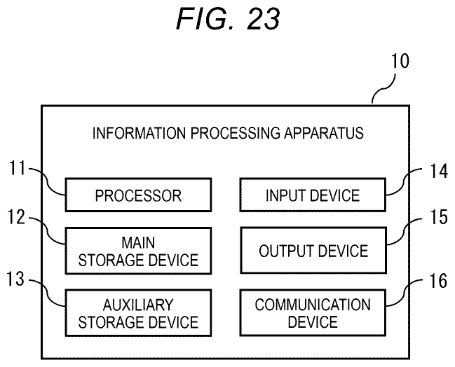

FIG. 23 is an example of an information processing apparatus (computer) used for implementing the distributed ledger system 1 described in the above embodiments. The client node 4 and the distributed ledger node 3 are implemented using, for example, an information processing apparatus 10 shown as an example.

The information processing apparatus 10 includes a processor 11, a main storage device 12 (memory), an auxiliary storage device 13 (external storage device), an input device 14, an output device 15, and a communication device 16. These are communicably connected via a bus, a communication cable, or the like. Examples of the information processing apparatus 10 include a personal computer, various server apparatuses, an office computer, a general-purpose machine (mainframe), a smartphone, and a tablet.

The information processing apparatus 10 may be implemented, in whole or in part, using a virtual information processing resource provided using a virtualization technology, a process space isolation technique, or the like, such as a virtual server provided by a cloud system. All or a part of functions provided by the information processing apparatus 10 may be implemented by, for example, a service provided by a cloud system via an application programming interface (API) or the like. All or a part of the functions provided by the information processing apparatus 10 may be implemented by using, for example, software as a service (SaaS), a platform as a service (PaaS), or an infrastructure as a service (IaaS).

The processor 11 is implemented using, for example, a central processing unit (CPU), a micro processing unit (MPU), a graphics processing unit (GPU), a field programmable gate array (FPGA), an application specific integrated circuit (ASIC), or an artificial intelligence (AI) chip.

The main storage device 12 is a device used when the processor 11 executes a program, and is, for example, a read only memory (ROM), a random access memory (RAM), or a non-volatile RAM (NVRAM). Various functions implemented in the respective components in the distributed ledger system 1 are implemented by the respective processor 11 by reading programs and data stored in the auxiliary storage device 13 to the main storage device 12 and executing the programs and data.

The auxiliary storage device 13 is a device that stores programs and data, and may include, for example, various storage systems such as a solid state drive (SSD), a hard disk drive, an optical storage device (a compact disc (CD), a digital versatile disc (DVD), or the like), or a network attached storage (NAS), a reading and writing device of a non-transitory recording medium such as an IC card, an SD card, or an optical recording medium, or a non-transitory storage area of a cloud server. The auxiliary storage device 13 can read programs and data from a non-transitory recording medium or another information processing apparatus including a non-transitory storage device via a recording medium reading device or the communication device 16. The programs and data stored in the auxiliary storage device 13 are read into the main storage device 12 as needed.

The input device 14 is an interface that receives an input of information from the outside, and is, for example, a keyboard, a mouse, a touch panel, a card reader, a pen input tablet, or a voice input device.

The output device 15 is an interface that outputs various types of information such as processing progress and processing results to the outside. The output device 15 is, for example, a display apparatus (a liquid crystal monitor, a liquid crystal display (LCD), a graphic card, or the like) that visualizes the various types of information, a device that converts the various types of information into audio (an audio output device (a speaker or the like)), or a device that converts the various types of information into characters (a printing device or the like). For example, the information processing apparatus 10 may receive and output information from and to another apparatus via the communication device 16.

The input device 14 and the output device 15 constitute a user interface that implements dialogue processing (receiving information, providing information, and the like) with the user.

The communication device 16 is a device that implements communication with another device. The communication device 16 is a wired or wireless communication interface that implements communication with another device via the communication network 5, and is, for example, a network interface card (NIC), a wireless communication module, or a USB module.

For example, an operating system, a file system, a database management system (DBMS) (a relational database, NoSQL, or the like), or a key-value store (KVS) may be introduced into the information processing apparatus 10.

Although the embodiments have been described above, the invention is not limited to the above-described embodiments, includes various modifications, and is not necessarily limited to those including all the configurations described above. A part of a configuration of a certain embodiment can be replaced with a configuration of another embodiment, and a configuration of another embodiment can be added to a configuration of a certain embodiment. It is possible to add, delete, or substitute another configuration with respect to a part of a configuration of each embodiment.

What is claimed is:

1. An information processing system comprising:
a plurality of nodes that are implemented using an information processing apparatus and are communicably connected to each other, wherein
at least a part of the plurality of nodes constitute a distributed ledger system that provides a distributed ledger,
the distributed ledger system enables execution of a smart contract according to a transaction sent from the plurality of nodes,
at least a part of the plurality of nodes provides a function for issuing or verifying a verifiable credential and a verifiable presentation, the function being implemented among a plurality of organizations by a self-sovereign identity (SSI) technology,
the information processing system
manages, as the smart contract, a program that implements
a creation request information generation function of receiving, from the nodes, a creation request for extraction information that is information specifying, for information in the verifiable credential, storage or non-storage in the distributed ledger of the distributed ledger system, and generating creation request information that is information based on the received creation request,
an approval or non-approval function of determining, by consensus formation among the nodes constituting the distributed ledger system, an approval or non-approval of the information specifying the storage or non-storage in the creation request information, and
an extraction information creation function of creating, when consensus is reached by the consensus formation, the extraction information based on the creation request information,
creates the extraction information by activating the creation request information generation function, the approval or non-approval function, and the extraction information creation function,
extracts information from the verifiable credential or the verifiable presentation based on a schema or a credential definition managed in the SSI technology and the extraction information, and
creates BC storage information that is information to be stored in the distributed ledger based on the extracted information.

2. The information processing system according to claim 1, wherein
the creation of the BC storage information is executed based on information extracted from the verifiable credential when a credential issuing organization that is one of the organizations issues the verifiable credential.

3. The information processing system according to claim 1, wherein
the creation of the BC storage information is executed based on information extracted from the verifiable presentation when a verifier that is one of the organizations verifies the verifiable presentation handed over from a credential holder that is one of the organizations.

4. The information processing system according to claim 1, wherein
at least one of the plurality of nodes provides a user interface that receives setting of the information on the creation request from a user and notifies the creation request information generation function of the received information.

5. The information processing system according to claim 1, wherein
at least one of the plurality of nodes provides a user interface that receives a decision of the approval or non-approval from a user and notifies the approval or non-approval function of a result of the decision.

6. The information processing system according to claim 5, wherein
when the decision of the approval or non-approval is received and the decision is a non-approval, the user interface receives information indicating a reason for the non-approval and notifies the approval or non-approval function of the received information, and
the approval or non-approval function presents the reason via the user interface when receiving the decision of the approval or non-approval from another of the organizations.

7. The information processing system according to claim 1, wherein
at least one of the plurality of nodes provides a user interface that presents the BC storage information to a user and receives an instruction to create the BC storage information.

8. The information processing system according to claim 1, wherein
a unique ID that is an identifier unique to the verifiable credential is assigned, and
the BC storage information includes the unique ID of the verifiable credential from which the BC storage information is extracted.

9. The information processing system according to claim 1, wherein
the approval or non-approval function determines that the consensus is reached in the consensus s formation when a total number of approvals from the nodes participating in the consensus formation exceeds a predetermined number or ratio.

10. The information processing system according to claim 1, wherein
the nodes constituting the distributed ledger system belong to different organizations,
the organizations are classified into groups based on an industry type and managed, and
the approval or non-approval function determines whether the consensus is reached in the consensus formation for each of the groups.

11. An information processing method using an information processing system, wherein
the information processing system includes a plurality of nodes that are implemented using an information processing apparatus and are communicably connected to each other,
at least a part of the plurality of nodes constitutes a distributed ledger system that provides a distributed ledger,
the distributed ledger system enables execution of a smart contract according to a transaction sent from the plurality of nodes,
at least a part of the plurality of nodes provides a function for issuing or verifying a verifiable credential and a verifiable presentation, the function being implemented among a plurality of organizations by a self-sovereign identity (SSI) technology,
the information processing method comprises causing the information processing system to execute processing of:
managing, as the smart contract, a program that implements
a creation request information generation function of receiving, from the nodes, a creation request for extraction information that is information specifying, for information in storage or non-storage in the verifiable credential, distributed ledger of the distributed ledger system, and generating creation request information that is information based on the received creation request,
an approval or non-approval function of determining, by consensus formation among the nodes constituting the distributed ledger system, an approval or non-approval of the information specifying the storage or non-storage in the creation request information, and
an extraction information creation function of creating, when consensus is reached by the consensus formation, the extraction information based on the creation request information;
creating the extraction information by activating the creation request information generation function, the approval or non-approval function, and the extraction information creation function;
extracting information from the verifiable credential or the verifiable presentation based on a schema or a credential definition managed in the SSI technology and the extraction information; and
creating BC storage information that is information to be stored in the distributed ledger based on the extracted information.

12. The information processing method according to claim 11, wherein
the information processing system executes the creation of the BC storage information based on information extracted from the verifiable credential when a credential issuing organization that is one of the organizations issues the verifiable credential.

13. The information processing method according to claim 11, wherein
the information processing system executes the creation of the BC storage information based on information extracted from the verifiable presentation when a verifier that is one of the organizations verifies the verifiable presentation handed over from a credential holder that is one of the organizations.

14. The information processing method according to claim 11, further comprising:
causing the information processing system to execute processing of
assigning a unique ID that is an identifier unique to the verifiable credential, and
including, in the BC storage information, the unique ID of the verifiable credential from which the BC storage information is extracted.

15. The information processing method according to claim 11, wherein
the approval or non-approval function determines that the consensus is reached in the consensus formation when a total number of approvals from the nodes participating in the consensus formation exceeds a predetermined number or ratio.
